(19) United States
(12) Patent Application Publication
(10) Pub. No.: US 2024/0290349 A1
(43) Pub. Date: Aug. 29, 2024

(54) MAGNETIC RECORDING MEDIUM

(71) Applicant: Sony Group Corporation, Tokyo (JP)

(72) Inventors: Minoru YAMAGA, Tokyo (JP); Yuuko KAMOSHITA, Tokyo (JP); Futoshi SASAKI, Tokyo (JP)

(21) Appl. No.: 18/572,658

(22) PCT Filed: Mar. 8, 2022
(86) PCT No.: PCT/JP2022/009998

§ 371 Date: Dec. 21, 2023

(30) Foreign Application Priority Data
Jul. 21, 2021 (JP) 2021-120555

(51) Int. Cl. G11B 5/70; G11B 5/72; G11B 5/78

(52) U.S. Cl. CPC G11B 5/7013; G11B 5/727; G11B 5/78

(57) ABSTRACT

An object is to provide a magnetic recording medium excellent in an electromagnetic conversion characteristic and traveling performance.

The present technology provides a magnetic recording medium including a magnetic layer containing a magnetic powder, the magnetic recording medium having an average magnetic cluster size of 1850 nm² or less, the average magnetic cluster size measured on the basis of an MFM image of a surface on a side of the magnetic layer, the magnetic layer containing first particles having conductivity and second particles having a Mohs hardness of 7 or more, in which protrusions are formed by the first particles and protrusions are formed by the second particles on the surface on the side of the magnetic layer, and a ratio (H₁/H₂) of an average height H₁ of the protrusions formed by the first particles to an average height H₂ of the protrusions formed by the second particles is 2.00 or less.

### TECHNICAL FIELD

The present technology relates to a magnetic recording medium.

### BACKGROUND ART

The amount of data collected and stored has been greatly increased, for example, with the development of IoT, big data, artificial intelligence, and the like. A magnetic recording medium is often used as a medium for recording a large amount of data.

Various technologies have been proposed for a magnetic recording medium. Patent Document 1 below discloses a magnetic recording medium including a non-magnetic support and a magnetic layer including ferromagnetic powder and a binding agent, in which the ferromagnetic powder is selected from the group consisting of hexagonal strontium ferrite powder and ε-iron oxide powder, and has an average particle size of 5 nm or more and 20 nm or less, the magnetic layer has a servo pattern, and an average area Sdc of magnetic clusters of the magnetic recording medium in a DC demagnetization state, measured by a magnetic force microscope is 0.2×10⁴ nm² or more and less than 5.0×10⁴ nm².

### CITATION LIST

### Patent Document

Patent Document 1: Japanese Patent Application Laid-Open No. 2020-140746

### SUMMARY OF THE INVENTION

### Problems to be Solved by the Invention

The capacity of data archived is increasing with the progress of IoT utilization, big data analysis, and the like. Accordingly, an increase in capacity of media used for archiving is also awaited. Magnetic recording tapes have also begun to be used for archiving, and are required to have higher capacities than ever before.

One conceivable method for increasing the capacity of a magnetic recording tape is improving the surface recording density. For example, micronization of magnetic particles is one of effective means for improving the surface recording density. However, magnetic particles micronized become more difficult to disperse. Micronization of magnetic particles does not improve the electromagnetic conversion characteristics of a magnetic tape unless the magnetic particles are dispersed. Therefore, the size of magnetically independent magnetic clusters is important. That is, it is desirable to optimize the dispersion state of magnetic particles so that the average magnetic cluster size is small.

Furthermore, an inorganic material is added to a magnetic recording tape, for example, in order to improve the traveling performance. For example, in order to prevent an increase in frictional force during traveling of a magnetic recording tape, for example, a solid lubricant component (such as carbon particles having a function as the solid lubricant, or the like) is used. Furthermore, a component having a polishing effect (furthermore, an anchor effect) (such as particles having a high Mohs hardness, more specifically, alumina, or the like) is used for magnetic head cleaning. If these two components are included in a magnetic layer of a magnetic recording tape, it is conceivable to improve the traveling performance by preventing an increase in frictional force and cleaning the magnetic head.

Here, if the magnetic powder is dispersed so as not to be magnetically aggregated, the degree of dispersion of these inorganic materials is also increased, and these inorganic materials may be buried in the magnetic layer. As a result, the effect of the inorganic materials is reduced. As described above, optimization of the dispersion state of magnetic particles improves the electromagnetic conversion characteristics, but may reduce the traveling performance. Conversely, optimization of the dispersion state of inorganic materials may cause insufficient dispersion of magnetic particles to reduce the electromagnetic conversion characteristics.

A main object of the present technology is to provide a magnetic recording tape that includes magnetic particles in an improved dispersion state and has excellent traveling performance. Furthermore, an object of the present technology is also to improve an electromagnetic conversion characteristic of a magnetic recording tape.

### Solutions to Problems

The present technology provides
a magnetic recording medium including a magnetic layer containing a magnetic powder,
the magnetic recording medium having an average magnetic cluster size of 1850 nm² or less, the average magnetic cluster size measured on the basis of an MFM image of a surface on a side of the magnetic layer,
the magnetic layer containing first particles having conductivity and second particles having a Mohs hardness of 7 or more, in which
protrusions are formed by the first particles and protrusions are formed by the second particles on the surface on the side of the magnetic layer, and
a ratio (H₁/H₂) of an average height H₁ of the protrusions formed by the first particles to an average height H₂ of the protrusions formed by the second particles is 2.00 or less.

The average height H₁ may be 13.0 nm or less.

The average height H₁ may be 12.0 nm or less.

The average height H₁ may be 11.0 nm or less.

The average height H₂ may be 7.5 nm or less.

The average height H₂ may be 7.0 nm or less.

The average height H₂ may be 6.5 nm or less.

The average magnetic cluster size may be 1800 nm² or less.

The average magnetic cluster size may be 1700 nm² or less.

The average magnetic cluster size may be 1600 nm² or less.

The magnetic recording medium may have an average thickness t_{T} of 5.1 μm or less.

The magnetic recording medium may have a coercive force Hc in a vertical direction of the magnetic recording medium of 165 kA/m or more and 300 kA/m or less.

The first particles may include carbon particles.

The second particles may include inorganic particles.

The number of the protrusions formed by the first particles on the surface on the side of the magnetic layer may be 2.5 or less per unit area (μm²).

The number of the protrusions formed by the second particles on the surface on the side of the magnetic layer may be 2.0 or more per unit area (μm²).

The magnetic layer may have an average thickness of 0.08 μm or less.

Furthermore, the present technology provides
a magnetic recording medium including a magnetic layer containing a magnetic powder,
the magnetic recording medium having an average magnetic cluster size of 1850 nm² or less, the average magnetic cluster size measured on the basis of an MFM image of a surface on a side of the magnetic layer,
the magnetic recording medium having a coercive force Hc in a vertical direction of the magnetic recording medium of 165 kA/m or more and 300 kA/m or less.

Furthermore, the present technology also provides a magnetic recording cartridge including the magnetic recording medium in a state of being wound around a reel, the magnetic recording medium accommodated in a case.

### BRIEF DESCRIPTION OF DRAWINGS

FIG. 1 is a cross-sectional view illustrating a configuration of a magnetic recording medium according to a first embodiment.

FIG. 2A is a view illustrating an example of a shape of a particle of a magnetic powder.

FIG. 2B is an example of a TEM photo of a sample cross section.

FIG. 2C is another example of a TEM photo of a sample cross section.

FIG. 3A is a schematic view illustrating a configuration of a cross section of a magnetic particle.

FIG. 3B is a schematic view illustrating a configuration of a cross section of a magnetic particle in a modified example.

FIG. 4A is a view for explaining image analysis processing of an MFM image.

FIG. 4B is a view for explaining image analysis processing of an MFM image.

FIG. 4C is a view for explaining image analysis processing of an MFM image.

FIG. 4D is a view for explaining image analysis processing of an MFM image.

FIG. 4E is a view for explaining image analysis processing of an MFM image.

FIG. 4F is a view for explaining image analysis processing of an MFM image.

FIG. 4G is a view for explaining image analysis processing of an MFM image.

FIG. 4H is a view for explaining image analysis processing of an MFM image.

FIG. 4I is a view for explaining image analysis processing of an MFM image.

FIG. 5A is an image showing an example of a surface shape imaged with an AFM.

FIG. 5B is a view showing an example of a protrusion analysis result by an AFM.

FIG. 5C is a view showing an example of protrusion height distribution with an AFM.

FIG. 6 is an example of a FE-SEM image.

FIG. 7 is a composite image in which an AFM image and a FE-SEM image are superimposed.

FIG. 8 is an enlarged view of a composite image in which an AFM image and a FE-SEM image are superimposed.

FIG. 9 is a view showing an example of an analysis result by an AFM for the line 1 (Line1) in FIG. 8.

FIG. 10 is a view illustrating a temporal change of a standard deviation σPES.

FIG. 11 is a view illustrating a temporal change of a standard deviation σPES.

FIG. 12 shows a view illustrating a temporal change of a standard deviation σPES, and a cross-sectional view schematically illustrating a change in a state of a protrusion formed by a carbon particle on a magnetic layer surface.

FIG. 13A is a view illustrating an example of a servo pattern in a servo band.

FIG. 13B is a view for illustrating a method of measuring a PES.

FIG. 13C is a view for illustrating correction of movement of a tape in the width direction.

FIG. 14 is a schematic view illustrating a configuration of a recording and reproducing apparatus.

FIG. 15 is a cross-sectional view illustrating a configuration of a magnetic recording medium in a modified example.

FIG. 16 is an exploded perspective view illustrating an example of a configuration of a magnetic recording cartridge.

FIG. 17 is a block diagram illustrating an example of a configuration of a cartridge memory.

FIG. 18 is an exploded perspective view illustrating an example of a configuration of a magnetic recording cartridge of a modified example.

### MODE FOR CARRYING OUT THE INVENTION

Hereinafter, preferred modes for implementing the present technology will be described. Note that embodiments described below illustrate representative embodiments of the present technology, and the scope of the present technology is not limited only to these embodiments.

The present technology will be described in the following order.
1. Description of Present Technology
2. First Embodiment
(1) Configuration of Magnetic Recording Medium
(2) Description of Each Layer
(3) Physical Properties and Structure
(4) Method of Manufacturing Magnetic Recording Medium
(5) Recording and Reproducing Apparatus
(6) Modified Examples
3. Second Embodiment
(1) Embodiment of Magnetic Recording Cartridge
(2) Modified Example of Magnetic Recording Cartridge
4. Examples

In the present description, in a case where a measurement method is described without a particular description of the measurement environment, the measurement is performed under an environment of 25° C.±2° C. and 50% RH±5% RH.

### 1. DESCRIPTION OF PRESENT TECHNOLOGY

The present technology provides a magnetic recording medium having an average magnetic cluster size of a specific value or less and having a ratio, between heights of protrusions formed by two kinds of particles respectively, of a specific value or less. In the magnetic recording medium, the dispersion state of the magnetic particles is improved, and in addition, effects of the two kinds of particles are exhibited, and the magnetic recording medium is excellent in traveling performance.

The magnetic recording medium according to the present technology includes a magnetic layer containing a magnetic powder, and the average magnetic cluster size measured on the basis of an MFM image of a surface on the magnetic layer side is, for example, 1850 nm² or less, more preferably 1800 nm² or less, and still more preferably 1750 nm² or less, 1700 nm^{z} or less, 1650 nm² or less, or 1600 nm² or less, and may be 1550 nm² or less or 1500 nm² or less. The average magnetic cluster size of the magnetic layer of the magnetic recording medium according to the present technology is as small as described above, that is, the surface recording density is high.

The lower limit of the average magnetic cluster size may be not particularly limited, or may be, for example, 500 nm^{z} or more, preferably 600 nm² or more, and more preferably 700 nm² or more, 800 nm² or more, 900 nm² or more, or 1000 nm^{z} or more. If the average magnetic cluster size is set to these values or more, the thermal stability of the magnetic recording medium is improved.

A method of measuring the average magnetic cluster size will be described in 2. (3) below.

Furthermore, the magnetic layer contains first particles having conductivity and second particles having a Mohs hardness of 7 or more. The first particles have conductivity, and may have a function as a solid lubricant. Furthermore, the second particles have a Mohs hardness of 7 or more, and may have a polishing effect (and an anchor effect) due to the Mohs hardness. The first particles and the second particles form protrusions on the surface on the magnetic layer side, and the ratio (H₁/H₂) of the average height (H₁) of the protrusions formed by the first particles to the average height (H₂) of the protrusions formed by the second particles is, for example, 2.00 or less, and may be more preferably 1.95 or less, and still more preferably 1.90 or less, 1.85 or less, 1.80 or less, 1.75 or less, or 1.70 or less. If the magnetic recording medium has a ratio (H₁/H₂) between the average heights of the protrusions within the above numerical range, a friction increase due to many times of traveling is less likely to occur, and the polishing force on the head can be appropriately maintained.

If the ratio (H₁/H₂) is within such a numerical range in the magnetic recording medium having an average magnetic cluster size as small as described above, the dispersion state of the magnetic particles in the magnetic layer is improved, and in addition, effects of the two kinds of particles are exhibited, and excellent traveling performance can be exhibited.

Furthermore, the lower limit of the ratio (H₁/H₂) between the average heights of the protrusions is not particularly limited, and may be, for example, 1.0 or more, preferably 1.1 or more, and more preferably 1.2 or more.

In the magnetic recording medium according to the present technology, the average height (H₁) of the protrusions formed by the first particles may be, for example, 13.0 nm or less, preferably 12.0 nm or less, more preferably 11.5 nm or less, and still more preferably 11.0 nm or less, 10.5 nm or less, 10.0 nm or less, 9.5 nm or less, 9.0 nm or less, or 8.5 nm or less.

If the magnetic recording medium has an average height (H₁) of the protrusions formed by the first particles within the above numerical range, a friction increase due to many times of traveling is less likely to occur, and the polishing force on the head can be appropriately maintained.

Furthermore, for improvement in an electromagnetic conversion characteristic, the average height (H₁) of the protrusions is preferably 12.0 nm or less, more preferably 11.5 nm or less, and still more preferably 11.0 nm or less, 10.5 nm or less, 10.0 nm or less, 9.5 nm or less, 9.0 nm or less, or 8.5 nm or less.

Furthermore, the lower limit of the average height (H₁) of the protrusions formed by the first particles is not particularly limited, and can be, for example, preferably 5.0 nm or more, more preferably 5.5 nm or more, and still more preferably 6.0 nm or more. As a result, the effect of adding the first particles is more effectively exhibited.

In the magnetic recording medium according to the present technology, the average height (H₂) of the protrusions formed by the second particles may be, for example, 8.0 nm or less, and can be preferably 7.5 nm or less, more preferably 7.0 nm or less, and still more preferably 6.5 nm or less, 6.0 nm or less, 5.5 nm or less, or 5.3 nm or less. If the magnetic recording medium has an average height (H₂) of the protrusions formed by the second particles within the above numerical range, a friction increase due to many times of traveling is less likely to occur, and the polishing force on the magnetic head can be appropriately maintained.

Furthermore, the average height (H₂) of the protrusions is preferably small, for example, 7.0 nm or less from the viewpoint of improving an electromagnetic conversion characteristic.

Furthermore, the lower limit of the average height (H₂) of the protrusions formed by the second particles is not particularly limited, and can be, for example, preferably 2.0 nm or more, more preferably 2.5 nm or more, and still more preferably 3.0 nm or more. As a result, the effect of adding the second particles is more effectively exhibited.

In a preferred embodiment of the present technology, the average height (H₁) of the protrusions formed by the first particles is 12.0 nm or less, preferably 11.5 nm or less, and more preferably 11.0 nm or less, 10.5 nm or less, 10.0 nm or less, 9.5 nm or less, 9.0 nm or less, or 8.5 nm or less, and the average height (H₂) of the protrusions formed by the second particles is 7.0 nm or less, preferably 6.5 nm or less, and more preferably 6.0 nm or less, 5.5 nm or less, or 5.3 nm or less. If the average heights of the protrusions formed by these two kinds of particles are within such numerical ranges, effects of these particles are more effectively exhibited to improve the traveling performance. Furthermore, if the average heights of the protrusions formed by these two kinds of particles are within such numerical ranges, the electromagnetic conversion characteristic is also improved.

Furthermore, the number of the protrusions formed by the first particles on the surface on the magnetic layer side is, for example, 3.0 or less, and may be preferably 2.5 or less, more preferably 2.0 or less, and still more preferably 1.9 or less, 1.8 or less, 1.7 or less, 1.6 or less, or 1.5 or less per unit area (μm²).

Furthermore, the number may be, for example, 0.3 or more, preferably 0.4 or more, more preferably 0.5 or more, and still more preferably 0.6 or more per unit area (μm²).

If the number is within the above numerical range, the effect of the first particles is more effectively exhibited, resulting in contribution to improvement in traveling performance. Furthermore, the number within the above numerical range also contributes to improvement in an electromagnetic conversion characteristic.

Furthermore, the number of the protrusions formed by the second particles on the surface on the magnetic layer side is, for example, 5.0 or less, and may be preferably 4.0 or less, more preferably 3.9 or less, and still more preferably 3.8 or less, 3.7 or less, 3.6 or less, or 3.5 or less per unit area (μm²).

Furthermore, the number may be, for example, 1.0 or more, preferably 1.5 or more, more preferably 1.7 or more, and still more preferably 2.0 or more per unit area (μm²).

If the number is within the above numerical range, the effect of the second particles is more effectively exhibited, resulting in contribution to improvement in traveling performance. Furthermore, the number within the above numerical range also contributes to improvement in an electromagnetic conversion characteristic.

Methods of measuring the average height (H₁) of the protrusions formed by the first particles, the average height (H₂) of the protrusions formed by the second particles, the ratio (H₁/H₂) between these heights, and the numbers of these protrusions per unit area will be described in 2. (3) below.

The magnetic recording medium according to the present technology is preferably an elongated magnetic recording medium, and can be, for example, a magnetic recording tape (particularly an elongated magnetic recording tape).

The magnetic recording medium according to the present technology may include a magnetic layer, a non-magnetic layer (underlayer), a base layer, and a back layer in this order, and may include other layers in addition to these layers. The other layers may be appropriately selected according to the type of the magnetic recording medium. The magnetic recording medium may be a coating type magnetic recording medium, that is, may be a magnetic recording medium manufactured by applying a material (particularly, coating material) for forming another layer to a base layer and drying the material.

The average thickness (average total thickness) t_{T} of the magnetic recording medium according to the present technology may be, for example, 5.7 μm or less, preferably 5.6 μm or less, more preferably 5.5 μm or less, 5.4 μm or less, 5.3 μm or less, 5.2 μm or less, 5.1 μm or less, or 5.0 μm or less, and still more preferably 4.6 μm or less or 4.4 μm or less. Since the magnetic recording medium may be thin as described above, for example, the length of the tape wound in one magnetic recording cartridge can be made longer, and therefore, the recording capacity per magnetic recording cartridge can be increased. The lower limit of the average thickness (average total thickness) t_{T} of the magnetic recording medium is not particularly limited, and is, for example, 3.5 μm≤t_{T}.

The average thickness tₘ of the magnetic layer of the magnetic recording medium according to the present technology can be preferably 0.08 μm or less, more preferably 0.07 μm or less, still more preferably 0.06 μm or less or 0.05 μm or less, and still even more preferably 0.04 μm or less. The lower limit of the average thickness tₘ of the magnetic layer is not particularly limited, and can be preferably 0.03 μm or more. A method of measuring the average thickness of the magnetic layer will be described in 2. (3) below.

The average thickness of the non-magnetic layer (also referred to as the underlayer) of the magnetic recording medium according to the present technology can be preferably 1.2 μm or less, preferably 1.1 μm or less, more preferably 1.0 μm or less, 0.9 μm or less, 0.8 μm or less, or 0.7 μm or less, and still more preferably 0.6 μm or less. Furthermore, the lower limit of the average thickness of the non-magnetic layer is not particularly limited, and can be preferably 0.2 μm or more, and more preferably 0.3 μm or more. A method of measuring the average thickness of the non-magnetic layer will be described in 2. (3) below.

The average thickness of the base layer (also referred to as the base material layer) of the magnetic recording medium according to the present technology can be preferably 4.5 μm or less, more preferably 4.2 μm or less, 4.0 μm or less, 3.8 μm or less, or 3.6 μm or less, and still more preferably 3.4 μm or less, 3.2 μm or less, or 3.0 μm or less. Furthermore, the lower limit of the average thickness of the base layer is not particularly limited, and can be, for example, 2.0 μm or more, and preferably 2.5 μm or more. A method of measuring the average thickness of the base layer will be described in 2. (3) below.

The average thickness of the back layer of the magnetic recording medium according to the present technology can be preferably 0.6 μm or less, more preferably 0.5 μm or less, and still more preferably 0.4 μm or less, 0.3 μm or less, 0.25 μm or less, or 0.2 μm or less. Furthermore, the lower limit of the average thickness of the back layer is not particularly limited, and can be, for example, 0.1 μm or more, and preferably 0.15 μm or more. A method of measuring the average thickness of the back layer will be described in 2. (3) below.

The average particle volume of the magnetic powder contained in the magnetic recording medium of the present technology may be, for example, 2200 nm³ or less, preferably 2000 nm³ or less, and more preferably 1900 nm³ or less, 1800 nm³ or less, 1700 nm³ or less, or 1600 nm³ or less. If the average particle volume is within the above numerical range, the average magnetic cluster size is easily adjusted to a desired range. Furthermore, the average particle volume within the above numerical range also contributes to improvement in an electromagnetic conversion characteristic. The average particle volume of the magnetic powder may be, for example, 500 nm³ or more, and particularly 700 nm² or more. A method of measuring the average particle volume of the magnetic powder will be described in 2. (3) below.

The magnetic recording medium according to the present technology can have, for example, at least one data band and at least two servo bands. The number of data bands can be, for example, 2 to 10, particularly 3 to 6, and more particularly 4 or 5. The number of servo bands can be, for example, 3 to 11, particularly 4 to 7, and more particularly 5 or 6. These servo bands and data bands may be arranged, for example, so as to extend in the longitudinal direction of the elongated magnetic recording medium (particularly, magnetic recording tape), and in particular, so as to be substantially parallel. The data bands and the servo bands can be provided in the magnetic layer. Examples of the magnetic recording medium having the data bands and the servo bands as described above include a magnetic recording tape conforming to the Linear Tape-Open (LTO) standard. That is, the magnetic recording medium according to the present technology may be a magnetic recording tape conforming to the LTO standard. For example, the magnetic recording medium according to the present technology may be a magnetic recording tape conforming to LTO8 or a later standard (for example, LTO9, LTO10, LTO11, LTO12, or the like).

The width of the elongated magnetic recording medium (particularly, magnetic recording tape) according to the present technology can be, for example, 5 mm to 30 mm, particularly 7 mm to 25 mm, more particularly 10 mm to 20 mm, and still more particularly 11 mm to 19 mm. The length of the elongated magnetic recording medium (particularly, magnetic recording tape) can be, for example, 500 m to 1500 m. For example, the tape width conforming to the LTO8 standard is 12.65 mm, and the length is 960 m.

### 2. FIRST EMBODIMENT

### (1) Configuration of Magnetic Recording Medium

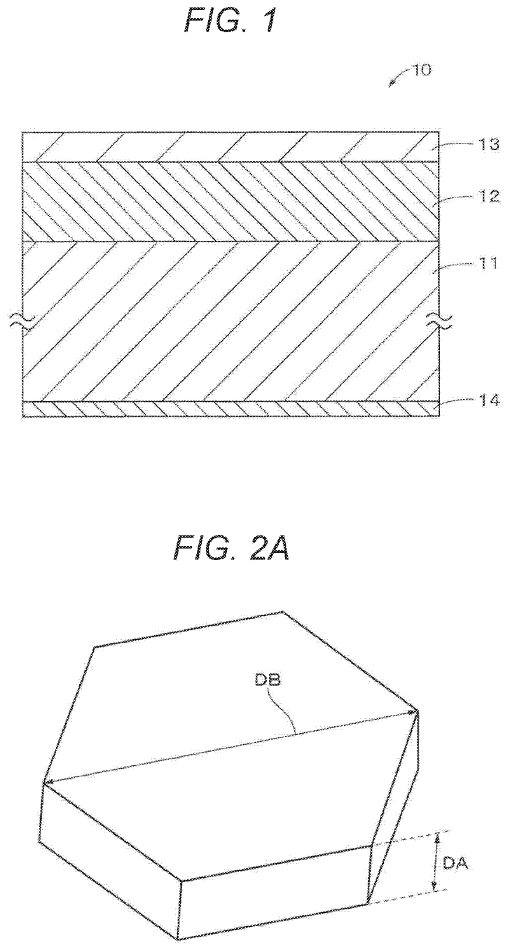

First, a configuration of a magnetic recording medium 10 according to a first embodiment will be described with reference to FIG. 1. The magnetic recording medium 10 is, for example, a magnetic recording medium subjected to vertical orientation processing. The magnetic recording medium 10 includes an elongated base layer (also referred to as a substrate) 11, a non-magnetic layer (also referred to as an underlayer) 12 provided on one principal plane of the base layer 11, a magnetic layer (also referred to as a recording layer) 13 provided on the non-magnetic layer 12, and a back layer 14 provided on the other principal plane of the base layer 11, as illustrated in FIG. 1. Hereinafter, among both the principal planes of the magnetic recording medium 10, the plane on which the magnetic layer 13 is provided will be referred to as a magnetic surface, and the plane opposite from the magnetic surface (the plane on which the back layer 14 is provided) will be referred to as a back surface.

The magnetic recording medium 10 has an elongated shape and travels in the longitudinal direction during recording and reproducing. Furthermore, the magnetic recording medium 10 may be configured to be capable of recording a signal at the shortest recording wavelength of preferably 100 nm or less, more preferably 75 nm or less, still more preferably 60 nm or less, and particularly preferably 50 nm or less, and can be used, for example, in a recording and reproducing apparatus whose shortest recording wavelength is in the above-described range. The recording and reproducing apparatus may include a ring type head as a recording head. The recording track width is, for example, 2 μm or less.

### (2) Description of Each Layer

### (Base Layer)

The base layer 11 can function as a support of the magnetic recording medium 10, and is, for example, an elongated flexible non-magnetic substrate, and particularly, can be a non-magnetic film. The average thickness of the base layer 11 can be, for example, preferably 4.5 μm or less, more preferably 4.2 μm or less, 4.0 μm or less, 3.8 μm or less, or 3.6 μm or less, and still more preferably 3.4 μm or less, 3.2 μm or less, or 3.0 μm or less. Note that the lower limit of the average thickness of the base layer 11 may be determined, for example, from the viewpoint of the limit of film formation, the function of the base layer 11, or the like, and may be, for example, 2.0 μm or more, 2.2 μm or more, 2.4 μm or more, or 2.6 μm or more. The base layer 11 can contain, for example, at least one of a polyester-based resin, a polyolefin-based resin, a cellulose derivative, a vinyl-based resin, an aromatic polyether ketone resin, or other polymer resins. In a case where the base layer 11 contains two or more of the above-described materials, the two or more materials may be mixed, copolymerized, or layered.

The polyester-based resin may be, for example, one or a mixture of two or more of polyethylene terephthalate (PET), polyethylene naphthalate (PEN), polybutylene terephthalate (PBT), polybutylene naphthalate (PBN), polycyclohexylenedimethylene terephthalate (PCT), polyethylene-p-oxybenzoate (PEB), and polyethylene bisphenoxycarboxylate. According to a preferred embodiment of the present technology, the base layer 11 may include PET or PEN.

The polyolefin-based resin may be, for example, one or a mixture of two or more of polyethylene (PE) and polypropylene (PP).

The cellulose derivative may be, for example, one or a mixture of two or more of cellulose diacetate, cellulose triacetate, cellulose acetate butyrate (CAB), and cellulose acetate propionate (CAP).

The vinyl-based resin may be, for example, one or a mixture of two or more of polyvinyl chloride (PVC) and polyvinylidene chloride (PVDC).

The aromatic polyether ketone resin may be, for example, one or a mixture of two or more of polyether ketone (PEK), polyether ether ketone (PEEK), polyether ketone ketone (PEKK), and polyether ether ketone ketone (PEEKK). According to a preferred embodiment of the present technology, the base layer 11 may include PEEK.

The other polymer resins may be, for example, one or a mixture of two or more of a polyamide, nylon (PA), an aromatic polyamide, aramid (aromatic PA), a polyimide (PI), an aromatic polyimide (aromatic PI), a polyamideimide (PAI), an aromatic polyamideimide (aromatic PAI), polybenzoxazole such as Zylon (registered trademark) (PBO), a polyether, a polyether ester, polyether sulfone (PES), polyether imide (PEI), polysulfone (PSF), polyphenylene sulfide (PPS), polycarbonate (PC), polyarylate (PAR), and a polyurethane (PU).

### (Magnetic Layer)

The magnetic layer 13 may be, for example, a perpendicular recording layer. The magnetic layer 13 contains a magnetic powder. The magnetic layer 13 contains first particles having conductivity and second particles having a Mohs hardness of 7 or more, in addition to the magnetic powder. Furthermore, the magnetic layer 13 can further contain, for example, a binder. The magnetic layer 13 may further contain, for example, an additive such as a lubricant, a corrosion inhibitor, or the like, as needed.

The average thickness tₘ of the magnetic layer 13 can be preferably 0.08 μm or less, more preferably 0.07 μm or less, and still more preferably 0.06 μm or less, 0.05 μm or less, or 0.04 μm or less. The lower limit of the average thickness tₘ of the magnetic layer 13 is not particularly limited, and can be preferably 0.03 μm or more. The average thickness tₘ of the magnetic layer 13 within the above numerical range contributes to improvement in an electromagnetic conversion characteristic.

The magnetic layer 13 is preferably a vertically oriented magnetic layer. In the present description, the word “vertical orientation” indicates that the squareness ratio Si measured in the longitudinal direction (traveling direction) of the magnetic recording medium 10 is 35% or less.

Note that the magnetic layer 13 may be an in-plane oriented (longitudinally oriented) magnetic layer. That is, the magnetic recording medium 10 may be a horizontal recording type magnetic recording medium. However, vertical orientation is more preferable in terms of a higher recording density.

### (Magnetic Powder)

Examples of the magnetic particles forming the magnetic powder contained in the magnetic layer 13 can include hexagonal ferrite, epsilon type iron oxide (ε-iron oxide), Co-containing spinel ferrite, gamma hematite, magnetite, chromium dioxide, cobalt-coated iron oxide, a metal, and the like, but are not limited thereto. The magnetic powder may be one or a combination of two or more thereof. The magnetic powder can preferably contain hexagonal ferrite, ε-iron oxide, or Co-containing spinel ferrite. The magnetic powder is particularly preferably hexagonal ferrite. The hexagonal ferrite can particularly preferably contain at least one of Ba or Sr. The ε-iron oxide can particularly preferably contain at least one of Al or Ga. These magnetic particles may be appropriately selected by those skilled in the art on the basis of factors such as the method of manufacturing the magnetic layer 13, a specification of the tape, a function of the tape, and the like.

A shape of the magnetic particles depends on a crystal structure of the magnetic particles. For example, barium ferrite (BaFe) and strontium ferrite can have a hexagonal plate shape. The ε-iron oxide can have a spherical shape. Cobalt ferrite can have a cubic shape. The metal can have a spindle shape. These magnetic particles are oriented in a manufacturing process of the magnetic recording medium 10.

The average particle size of the magnetic powder can be preferably 50 nm or less, more preferably 40 nm or less, and still more preferably 30 nm or less, 25 nm or less, 22 nm or less, 21 nm or less, or 20 nm or less. The average particle size can be, for example, 10 nm or more, and preferably 12 nm or more.

The average aspect ratio of the magnetic powder may be, for example, 1.0 or more and 3.0 or less, and may be 1.0 or more and 2.9 or less.

(Embodiment in which Magnetic Powder Contains Hexagonal Ferrite)

According to a preferred embodiment of the present technology, the magnetic powder contains hexagonal ferrite, and more particularly, can include a powder of nanoparticles containing hexagonal ferrite (hereinafter, referred to as “hexagonal ferrite particles”). The hexagonal ferrite preferably has an M-type structure. The hexagonal ferrite has, for example, a hexagonal plate shape or a substantially hexagonal plate shape. The hexagonal ferrite can preferably contain at least one of Ba, Sr, Pb, or Ca, and more preferably at least one of Ba, Sr, or Ca. The hexagonal ferrite may specifically be, for example, one or a combination of two or more selected from barium ferrite, strontium ferrite, and calcium ferrite, and is particularly preferably barium ferrite or strontium ferrite. The barium ferrite may further contain at least one of Sr, Pb, or Ca in addition to Ba. The strontium ferrite may further contain at least one of Ba, Pb, or Ca in addition to Sr.

More specifically, the hexagonal ferrite can have an average composition represented by a general formula MFe₁₂O₁₉. Here, M is, for example, at least one metal of Ba, Sr, Pb, or Ca, and preferably at least one metal of Ba or Sr. M may be a combination of Ba and one or more metals selected from the group consisting of Sr, Pb, and Ca. Furthermore, M may be a combination of Sr and one or more metals selected from the group consisting of Ba, Pb, and Ca. In the above-described general formula, a part of Fe may be substituted with another metal element.

In a case where the magnetic powder includes a powder of hexagonal ferrite particles, the average particle size of the magnetic powder can be preferably 50 nm or less, more preferably 40 nm or less, and still more preferably 30 nm or less, 25 nm or less, 22 nm or less, 21 nm or less, or 20 nm or less. The average particle size can be, for example, 10 nm or more, preferably 12 nm or more, and more preferably 15 nm or more. For example, the average particle size of the magnetic powder can be 10 nm or more and 50 nm or less, 10 nm or more and 40 nm or less, 12 nm or more and 30 nm or less, 12 nm or more and 25 nm or less, or 15 nm or more and 22 nm or less. If the average particle size of the magnetic powder is the above-described upper limit or less (for example, 50 nm or less, and particularly 30 nm or less), an excellent electromagnetic conversion characteristic (for example, SNR) can be obtained in the magnetic recording medium 10 having a high recording density. If the average particle size of the magnetic powder is the above-described lower limit or more (for example, 10 nm or more, and preferably 12 nm or more), the dispersibility of the magnetic powder is further improved, and a more excellent electromagnetic conversion characteristic (for example, SNR) can be obtained.

In a case where the magnetic powder includes a powder of hexagonal ferrite particles, the average aspect ratio of the magnetic powder can be preferably 1.0 or more and 3.0 or less, more preferably 1.0 or more and 2.9 or less, and still more preferably 2.0 or more and 2.9 or less. If the average aspect ratio of the magnetic powder is within the above numerical range, aggregation of the magnetic powder can be suppressed and in addition, when the magnetic powder is vertically oriented at a step of forming the magnetic layer 13, resistance applied to the magnetic powder can be suppressed. As a result, the vertical orientation of the magnetic powder can be improved.

In a case where the magnetic powder includes a hexagonal ferrite particle powder, the average particle size and the average aspect ratio of the magnetic powder are determined as follows. First, a magnetic recording medium (hereinafter, also referred to as a “magnetic tape”) accommodated in a magnetic recording cartridge is unwound, and a magnetic tape to be measured is cut out by about 50 mm. For example, in the case of a magnetic recording cartridge 10A as illustrated in FIG. 19, the cut-out position may be a position 30 m from a connection portion 221 between the magnetic tape T and the leader tape LT in the longitudinal direction. Subsequently, the magnetic tape to be measured is processed with a FIB method or the like to perform thinning. In a case where the FIB method is used, formation of a carbon layer and a tungsten layer as protective films is performed as pre-processing for observing a TEM image of a cross section described below. The carbon layer is formed on a magnetic layer side surface and a back layer side surface of the magnetic tape with a vapor deposition method, and then the tungsten layer is further formed on the magnetic layer side surface with a vapor deposition method or a sputtering method. The thinning is performed in the length direction (longitudinal direction) of the magnetic tape.

That is, a cross section parallel to both the longitudinal direction and the thickness direction of the magnetic tape is formed by the thinning.

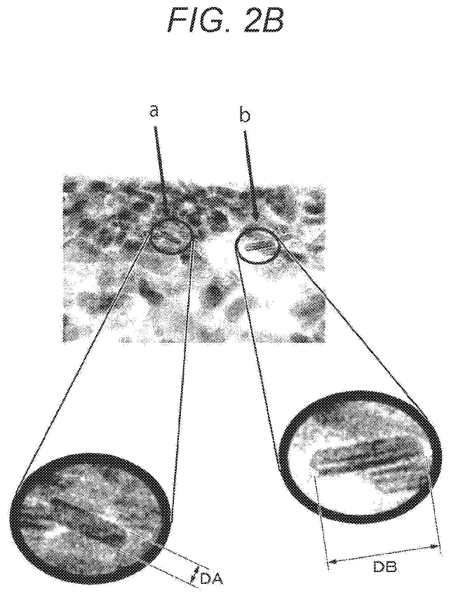

Using a transmission electron microscope (H-9500 manufactured by Hitachi High-Technologies Corporation), the above-described cross section of the obtained thin piece sample is observed at an acceleration voltage of 200 kV and a total magnification of 500,000 times so that the entire magnetic layer is included in the thickness direction of the magnetic layer, and a TEM photo is imaged. The number of TEM photos prepared is such that 50 particles can be extracted in which the plate diameter DB and the plate thickness DA (see FIG. 2A) shown below can be measured.

In the present description, the size of the hexagonal ferrite particle (hereinafter, referred to as “particle size”) is determined as follows. In a case where a particle observed in the TEM photo has a plate shape or a columnar shape as illustrated in FIG. 2A (note that the thickness or height is smaller than the long diameter of the plate surface or the bottom surface), the value of the long diameter of the plate surface or the bottom surface is the value of the plate diameter DB. The value of the thickness or height of the particle observed in the TEM photo is the value of the plate thickness DA. In a case where a particle observed in the TEM photo has a hexagonal plate surface or bottom surface, the long diameter means the longest diagonal distance. In a case where the thickness or height of one particle is not constant in the particle, the maximum thickness or height of the particle is the plate thickness DA.

Next, 50 particles to be extracted from the imaged TEM photo are selected according to the following criteria. A particle having a part out of the visual field of the TEM photo is not to be measured, and a particle having a clear outline and existing separately is to be measured. In a case where particles overlap, each particle is to be measured as a single particle when the boundary between the particles is clear and the entire shape of each particle can be determined, but a particle in which the boundary is not clear and the entire shape of the particle cannot be determined is not to be measured as the shape of the particle cannot be determined.

FIGS. 2B and 2C show an example of a TEM photo. In these figures, for example, the particles indicated by the arrows a and d are selected because the plate thickness of each particle (thickness or height of each particle) DA can be clearly recognized. The plate thickness DA of each of the selected 50 particles is measured. The plate thicknesses DA thus obtained are simply averaged (arithmetically averaged) to obtain an average plate thickness DAₐᵥₑ. The average plate thickness DAₐᵥₑ is the average particle plate thickness. Subsequently, the plate diameter DB of each magnetic powder is measured. In order to measure the plate diameter DB of the particles, 50 particles in which the plate diameter DB of each particle can be clearly recognized are selected from the imaged TEM photo. For example, in these figures, the particles, for example, indicated by the arrows b and c are selected because the plate diameter DB can be clearly recognized. The plate diameter DB of each of the selected 50 particles is measured. The plate diameters DB thus obtained are simply averaged (arithmetically averaged) to obtain an average plate diameter DBₐᵥₑ. The average plate diameter DBₐᵥₑ is an average particle size.

In a case where the magnetic powder includes a powder of hexagonal ferrite particles, the average particle volume of the magnetic powder may be preferably 1800 nm³ or less, more preferably 1600 nm³ or less, more preferably 1400 nm³ or less, and still more preferably 1200 nm or less, 1100 nm³ or less, or 1000 nm³ or less. The average particle volume of the magnetic powder can be preferably 500 nm³ or more, and more preferably 700 nm³ or more.

If the average particle volume of the magnetic powder is the above-described upper limit or less (for example, 2000 nm³ or less), an excellent electromagnetic conversion characteristic (for example, SNR) can be obtained in the magnetic recording medium 10 having a high recording density. If the average particle volume of the magnetic powder is the above-described lower limit or more (for example, 500 nm³ or more), the dispersibility of the magnetic powder is further improved, and a more excellent electromagnetic conversion characteristic (for example, SNR) can be obtained.

The average particle volume of the magnetic powder is determined as follows. First, as described regarding the method of calculating the average particle size of the magnetic powder, the average plate thickness DAₐᵥₑ and the average plate diameter DBₐᵥₑ are determined. Next, the average particle volume V of the magnetic powder is determined with the following formula.

$$V = \frac{3 \sqrt{3}}{8} \times {DA}_{ave} \times {DB}_{ave} \times {DB}_{ave} \qquad [ Math . 1 ]$$

According to a particularly preferred embodiment of the present technology, the magnetic powder can be a barium ferrite magnetic powder or a strontium ferrite magnetic powder, and more preferably a barium ferrite magnetic powder. A barium ferrite magnetic powder contains iron oxide magnetic particles including barium ferrite as a main phase (hereinafter, referred to as “barium ferrite particles”). A barium ferrite magnetic powder has high reliability of data recording so that, for example, the coercivity does not deteriorate even in a high-temperature and high-humidity environment. From such a viewpoint, a barium ferrite magnetic powder is preferable as the magnetic powder.

The average particle size of the barium ferrite magnetic powder is 22 nm or less, more preferably 10 nm or more and 20 nm or less, and still more preferably 12 nm or more and 18 nm or less.

In a case where the magnetic layer 13 contains a barium ferrite magnetic powder as the magnetic powder, the average thickness tₘ [nm] of the magnetic layer 13 is preferably 90 nm or less, and more preferably 80 nm or less. For example, the average thickness tₘ of the magnetic layer 13 may be 35 nm≤tm≤90 nm or 35 nm≤tₘ≤80 nm.

Furthermore, the coercive force Hc1 measured in the thickness direction (vertical direction) of the magnetic recording medium 10 is preferably 2010 [Ce] or more and 3520 [Oe] or less, more preferably 2070 [Oe] or more and 3460 [Oe] or less, and still more preferably 2140 [Oe] or more and 3390 [Oe] or less.

(Embodiment in which Magnetic Powder Contains ε-Iron Oxide)

According to another preferred embodiment of the present technology, the magnetic powder can preferably include a powder of nanoparticles containing ε-iron oxide (hereinafter, referred to as “ε-iron oxide particles”). Even if fine particles, the ε-iron oxide particles can obtain high coercive force. ε-Iron oxide contained in the ε-iron oxide particles is preferably crystal-oriented preferentially in the thickness direction (vertical direction) of the magnetic recording medium 10.

The ε-iron oxide particles have a spherical shape or a substantially spherical shape, or have a cubic shape or a substantially cubic shape. The ε-iron oxide particles have a shape as described above, and therefore in a case where the ε-iron oxide particles are used as the magnetic particles, the contact area between the particles in the thickness direction of the medium can be reduced and aggregation of the particles can be suppressed as compared with a case where barium ferrite particles having a hexagonal plate shape are used as the magnetic particles. Therefore, the dispersibility of the magnetic powder can be enhanced, and a more excellent SNR can be obtained.

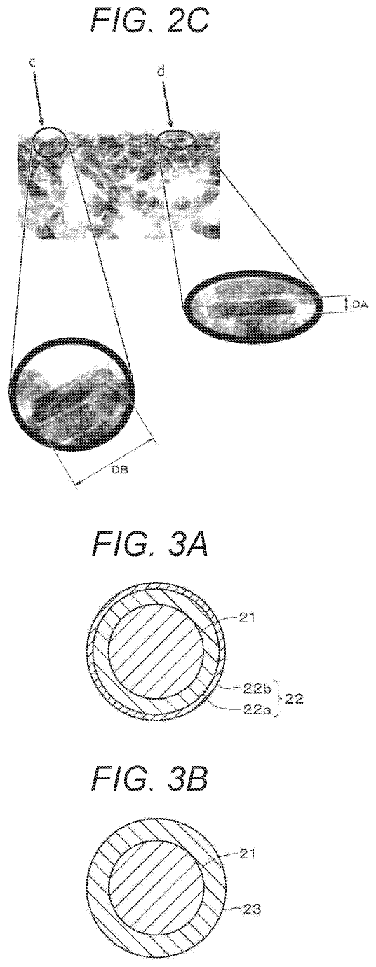

The ε-iron oxide particles may have a core-shell structure. Specifically, as illustrated in FIG. 3A, the ε-iron oxide particle includes a core 21 and a shell 22 having a two-layer structure provided around the core 21. The shell 22 having a two-layer structure includes a first shell 22a provided on the core 21 and a second shell 22b provided on the first shell 22a.

The core 21 contains ε-iron oxide. The ε-iron oxide contained in the core 21 preferably includes a ε-Fe₂O₃ crystal as a main phase, and more preferably includes a single-phase ε-Fe₂O₃.

The first shell 22a covers at least a part of the periphery of the core 21. Specifically, the first shell 22a may partially cover the periphery of the core 21 or may cover the entire periphery of the core 21. From the viewpoint of achieving sufficient exchange coupling between the core 21 and the first shell 22a and improving a magnetic characteristic, the entire surface of the core 21 is preferably covered.

The first shell 22a is a so-called soft magnetic layer, and can contain, for example, a soft magnetic material such as α-Fe, a Ni—Fe alloy, or a Fe—Si—Al alloy. α-Fe may also be obtained by reducing E-iron oxide contained in the core 21.

The second shell 22b is an oxide coating as an oxidation resistant layer. The second shell 22b can contain α-iron oxide, aluminum oxide, or silicon oxide. α-Iron oxide can include, for example, at least one iron oxide of Fe₃O₄, Fe₂O₃, or FeO. In a case where the first shell 22a contains α-Fe (a soft magnetic material), α-iron oxide may be obtained by oxidizing α-Fe contained in the first shell 22a.

If the ε-iron oxide particle has the first shell 22a as described above, thermal stability can be ensured, and thus the coercive force Hc of the core 21 alone can be maintained at a large value and/or the coercive force Hc of whole ε-iron oxide particles (core-shell particles) can be adjusted to a coercive force Hc suitable for recording. Furthermore, if the ε-iron oxide particle has the second shell 22b as described above, it is possible to suppress deterioration of a characteristic of the ε-iron oxide particle caused by rust and the like on a particle surface due to exposure of the ε-iron oxide particle to the air at a manufacturing process of the magnetic recording medium 10 and before the process. Therefore, deterioration of a characteristic of the magnetic recording medium 10 can be suppressed.

As illustrated in FIG. 3B, the ε-iron oxide particle may have a shell 23 having a single-layer structure. In this case, the shell 23 has a configuration similar to that of the first shell 22a. However, from the viewpoint of suppressing deterioration of a characteristic of the ε-iron oxide particle, the ε-iron oxide particle preferably has the shell 22 having a two-layer structure.

The ε-iron oxide particle may contain an additive instead of having a core-shell structure, or may have a core-shell structure and contain an additive. In these cases, a part of Fe in the ε-iron oxide particle is substituted with the additive. If the ε-iron oxide particle contains an additive, the coercive force Hc of whole ε-iron oxide particles can also be adjusted to a coercive force Hc suitable for recording, and therefore the recordability can be improved. The additive is a metal element other than iron, preferably a trivalent metal element, and more preferably one or more selected from the group consisting of aluminum (Al), gallium (Ga), and indium (In).

Specifically, the ε-iron oxide containing an additive is an ε-Fe₂₋ₓMₓO₃ crystal (here, M is a metal element other than iron, preferably a trivalent metal element, and more preferably one or more selected from the group consisting of Al, Ga, and In, and x is, for example, 0<x<1).

The average particle size (average maximum particle size) of the magnetic powder is preferably 22 nm or less, more preferably 8 nm or more and 22 nm or less, and still more preferably 12 nm or more and 22 nm or less. In the magnetic recording medium 10, a region having a size of ½ of a recording wavelength is an actual magnetization region. For this reason, an excellent SNR can be obtained by setting the average particle size of the magnetic powder to half or less of the shortest recording wavelength. Therefore, if the average particle size of the magnetic powder is 22 nm or less, an excellent electromagnetic conversion characteristic (for example, SNR) can be obtained in the magnetic recording medium 10 having a high recording density (for example, the magnetic recording medium 10 configured to be capable of recording a signal at the shortest recording wavelength of 44 nm or less). Meanwhile, if the average particle size of the magnetic powder is 8 nm or more, the dispersibility of the magnetic powder is further improved, and a more excellent electromagnetic conversion characteristic (for example, SNR) can be obtained.

The average aspect ratio of the magnetic powder is preferably 1.0 or more and 3.0 or less, more preferably 1.0 or more and 2.9 or less, and still more preferably 1.0 or more and 2.5 or less. If the average aspect ratio of the magnetic powder is in the above numerical range, aggregation of the magnetic powder can be suppressed, and when the magnetic powder is vertically oriented at a step of forming the magnetic layer 13, resistance applied to the magnetic powder can be suppressed. Therefore, the vertical orientation of the magnetic powder can be improved.

In a case where the magnetic powder contains ε-iron oxide particles, the average particle size and the average aspect ratio of the magnetic powder are determined as follows. First, as described regarding a case where the magnetic powder includes a hexagonal ferrite particle powder, a magnetic recording medium to be measured is cut out. The magnetic recording medium to be measured is processed with a focused ion beam (FIB) method or the like to perform thinning. In a case where the FIB method is used, formation of a carbon film and a tungsten thin film as protective films is performed as pre-processing for observing a TEM image of a cross section described below. The carbon film is formed on a magnetic layer side surface and a back layer side surface of the magnetic recording medium with a vapor deposition method, and then the tungsten thin film is further formed on the magnetic layer side surface with a vapor deposition method or a sputtering method. The thinning is performed in the length direction (longitudinal direction) of the magnetic recording medium. That is, a cross section parallel to both the longitudinal direction and the thickness direction of the magnetic recording medium is formed by the thinning.

Using a transmission electron microscope (H-9500 manufactured by Hitachi High-Technologies Corporation), the above-described cross section of the obtained thin piece sample is observed at an acceleration voltage of 200 kV and a total magnification of 500,000 times so that the entire magnetic layer 13 is included in the thickness direction of the magnetic layer 13, and a TEM photo is imaged.

Next, 50 particles whose shapes can be clearly recognized are selected from the imaged TEM photo, and a long axis length DL and a short axis length DS of each particle are measured. Here, the long axis length DL means the largest one of the distances between two parallel lines drawn from all angles so as to be in contact with the outline of a particle (so-called maximum Feret diameter). Meanwhile, the short axis length DS means the largest one of the lengths of a particle in a direction orthogonal to the long axis (DL) of the particle.

Subsequently, the measured long axis lengths DL of the 50 particles are simply averaged (arithmetically averaged) to determine the average long axis length DLₐᵥₑ. The average long axis length DLₐᵥₑ determined in this manner is regarded as the average particle size of the magnetic powder. Furthermore, the measured short axis lengths DS of the 50 particles are simply averaged (arithmetically averaged) to determine the average short axis length DSₐᵥₑ. Then, the average aspect ratio (DLₐᵥₑ/DSₐᵥₑ) of the particles is determined from the average long axis length DLₐᵥₑ and the average short axis length DSₐᵥₑ.

The average particle volume of the magnetic powder may be preferably 1800 nm³ or less, more preferably 1600 nm³ or less, more preferably 1400 nm³ or less, and still more preferably 1200 nm- or less, 1100 nm³ or less, or 1000 nm- or less. The average particle volume of the magnetic powder can be preferably 500 nm³ or more, and more preferably 700 nm³ or more.

If the average particle volume of the magnetic powder is the above-described upper limit or less (for example, 2000 nm³ or less), an excellent electromagnetic conversion characteristic (for example, SNR) can be obtained in the magnetic recording medium 10 having a high recording density. If the average particle volume of the magnetic powder is the above-described lower limit or more (for example, 500 nm³ or more), the dispersibility of the magnetic powder is further improved, and a more excellent electromagnetic conversion characteristic (for example, SNR) can be obtained.

In a case where the ε-iron oxide particles have a spherical or a substantially spherical shape, the average particle volume of the magnetic powder is determined as follows. First, the average long axis length DLₐᵥₑ is determined in a manner similar to the above-described method of calculating the average particle size of the magnetic powder. Next, the average particle volume V of the magnetic powder is determined with the following formula.

$$V = ( π / 6 ) \times {DL}_{ave}^{3}$$

In a case where the ε-iron oxide particles have a cubic shape, the average particle volume of the magnetic powder is determined as follows. The magnetic recording medium 10 is processed with a focused ion beam (FIB) method or the like to perform thinning. In a case where the FIB method is used, formation of a carbon film and a tungsten thin film as protective films is performed as pre-processing for observing a TEM image of a cross section described below. The carbon film is formed on a magnetic layer side surface and a back layer side surface of the magnetic recording medium 10 with a vapor deposition method, and then the tungsten thin film is further formed on the magnetic layer side surface with a vapor deposition method or a sputtering method. The thinning is performed in the length direction (longitudinal direction) of the magnetic recording medium 10. That is, a cross section parallel to both the longitudinal direction and the thickness direction of the magnetic recording medium 10 is formed by the thinning.

Using a transmission electron microscope (H-9500 manufactured by Hitachi High-Technologies Corporation), a cross section of the obtained thin piece sample is observed at an acceleration voltage of 200 kV and a total magnification of 500,000 times so that the entire magnetic layer 13 is included in the thickness direction of the magnetic layer 13, and a TEM photo is obtained. Note that the magnification and the acceleration voltage may be appropriately adjusted according to the type of the apparatus.

Next, 50 particles whose shapes can be clearly identified are selected from the imaged TEM photo, and the side length DC of each particle is measured. Subsequently, the measured side lengths DC of the 50 particles are simply averaged (arithmetically averaged) to determine the average side length DCₐᵥₑ. Next, the average particle volume Vₐᵥₑ of the magnetic powder (particle volume) is determined from the following formula using the average side length DCₐᵥₑ.

Vₐᵥₑ=DCₐᵥₑ³

The coercive force Hc of the ε-iron oxide particles is preferably 2500 Oe or more, and more preferably 2800 Oe or more and 4200 e or less.

(Embodiment in which Magnetic Powder Contains Co-Containing Spinel Ferrite)

According to still another preferred embodiment of the present technology, the magnetic powder can include a powder of nanoparticles containing Co-containing spinel ferrite (hereinafter, also referred to as “cobalt ferrite particles”). That is, the magnetic powder can be a cobalt ferrite magnetic powder. The cobalt ferrite particles preferably have uniaxial crystal anisotropy. The cobalt ferrite magnetic particles have, for example, a cubic shape or a substantially cubic shape. The Co-containing spinel ferrite may further contain one or more selected from the group consisting of Ni, Mn, Al, Cu, and Zn in addition to Co.

The cobalt ferrite has, for example, an average composition represented by the following formula.

CoₓM_{y}Fe₂O_{z}

(Here, in the formula, M is, for example, one or more metals selected from the group consisting of Ni, Mn, Al, Cu, and Zn, x is a value within a range of 0.4≤x≤1.0, y is a value within a range of 0≤y≤0.3, where x and y satisfy a relationship of (x+y)≤1.0, z is a value within a range of 3≤z≤4, and a part of Fe may be substituted with another metal element.)

The average particle size of the cobalt ferrite magnetic powder is preferably 21 nm or less, and more preferably 19 nm or less. The coercive force Hc of the cobalt ferrite magnetic powder is preferably 2500 Oe or more, and more preferably 2600 Oe or more and 3500 Oe or less.

In a case where the magnetic powder includes a powder of cobalt ferrite particles, the average particle size of the magnetic powder is preferably 25 nm or less, and more preferably 10 nm or more and 19 nm or less. If the average particle size of the magnetic powder is as small as described above, an excellent electromagnetic conversion characteristic (for example, SNR) can be obtained in the magnetic recording medium 10 having a high recording density. Meanwhile, if the average particle size of the magnetic powder is 10 nm or more, the dispersibility of the magnetic powder is further improved, and a more excellent electromagnetic conversion characteristic (for example, SNR) can be obtained. In a case where the magnetic powder contains a powder of cobalt ferrite particles, the average aspect ratio and the average particle size of the magnetic powder are determined with the same method as in a case where the magnetic powder contains ε-iron oxide particles.

The average particle volume of the magnetic powder may be preferably 2000 nm³ or less, more preferably 1900 nm³ or less, more preferably 1800 nm³ or less, and still more preferably 1700 nm³ or less, 1600 nm³ or less, or 1500 nm³ or less. The average particle volume of the magnetic powder can be preferably 500 nm³ or more, and more preferably 700 nm³ or more.

If the average particle volume of the magnetic powder is the above-described upper limit or less (for example, 2000 nm³ or less), an excellent electromagnetic conversion characteristic (for example, SNR) can be obtained in the magnetic recording medium 10 having a high recording density. If the average particle volume of the magnetic powder is the above-described lower limit or more (for example, 500 nm³ or more), the dispersibility of the magnetic powder is further improved, and a more excellent electromagnetic conversion characteristic (for example, SNR) can be obtained.

### (First Particles)

The first particles have conductivity. As the first particles, fine particles can be used that contain carbon as a main component, and the fine particles may be, for example, preferably carbon particles. Examples of such carbon particles include carbon black. As the carbon black, for example, Asahi #15 and #15HS manufactured by Asahi Carbon Co., Ltd., SEAST TA manufactured by TOKAI CARBON CO., LTD., and the like can be used. Furthermore, hybrid carbon may be used in which carbon is attached to a silica particle surface.

The average particle size (arithmetic average of particle diameters measured using electron microscopy) of the first particles (in particular, carbon particles such as carbon black) may be, for example, 15 nm or more, preferably 30 nm or more, and more preferably 50 nm or more. Furthermore, the average particle size may be, for example, 200 nm or less, preferably 180 nm or less, and more preferably 150 nm or less, 130 nm or less, or 120 nm or less. The numerical range of the average particle size may be appropriately selected from these upper limits and lower limits, and may be, for example, 50 nm to 200 nm, and is preferably 50 nm to 180 nm, more preferably 50 nm to 150 nm, and still more preferably 50 nm to 130 nm.

The nitrogen adsorption specific surface area of the first particles (in particular, carbon particles such as carbon black) may be, for example, 5 m²/g to 50 m²/g, and is preferably 7 m²/g to 50 m²/g, more preferably 10 m²/g to 50 m²/g, and still more preferably 12 m²/g to 50 m²/g.

The iodine adsorption of the first particles (in particular, carbon particles such as carbon black) may be, for example, 5 mg/g to 50 mg/g, and is preferably 7 mg/g to 50 mg/g, more preferably 10 mg/g to 50 mg/g, and still more preferably 12 mg/g to 50 mg/g.

### (Second Particles)

The second particles may have a Mohs hardness of 7 or more, preferably 7.5 or more, more preferably 8 or more, and still more preferably 8.5 or more from the viewpoint of suppressing deformation due to contact with a magnetic head. From the viewpoint of suppressing wear of the head, the Mohs hardness of the second particles may be, for example, 10 or less, and preferably 9.5 or less. That is, the second particles may include a material having such a Mohs hardness.

The second particles may be preferably inorganic particles. The second particles may be, for example, α-alumina (the a transformation rate may be, for example, 90% or more), β-alumina, γ-alumina, silicon carbide, chromium oxide, cerium oxide, α-iron oxide, corundum, silicon nitride, titanium carbide, titanium oxide, silicon dioxide, tin oxide, magnesium oxide, tungsten oxide, zirconium oxide, boron nitride, zinc oxide, calcium carbonate, calcium sulfate, barium sulfate, molybdenum disulfide, needle-like α-iron oxide obtained by subjecting a raw material of magnetic iron oxide to dehydration and annealing treatment, a product obtained by subjecting the above-described needle-like α-iron oxide to surface treatment with aluminum and/or silica as necessary, diamond powder, or a combination of two or more thereof. As the second particles, alumina particles such as α-alumina, β-alumina, γ-alumina, and the like, and silicon carbide are preferably used. These second particles may have any shape such as a needle shape, a spherical shape, a dice shape, or the like, and preferably have a shape including a corner part because, for example, such particles have high abrasivity.

The average particle size (for example, arithmetic average of particle diameters measured using electron microscopy) of the second particles (in particular, inorganic particles such as alumina) may be, for example, 15 nm or more, preferably 30 nm or more, and more preferably 50 nm or more. Furthermore, the average particle size may be, for example, 200 nm or less, preferably 180 nm or less, and more preferably 150 nm or less, 130 nm or less, or 120 nm or less. The numerical range of the average particle size may be appropriately selected from these upper limits and lower limits, and may be, for example, 50 nm to 180 nm, and is preferably 60 nm to 150 nm, and more preferably 60 nm to 120 nm.

The second particles (in particular, inorganic particles such as alumina) may have no conductivity. That is, the second particles may be not particles having conductivity like that of the first particles.

### (Average Height of Protrusions Formed by First Particles and Second Particles Respectively)

A protrusion is formed by each of the first particles and the second particles on the magnetic layer side surface. The ratio (H₁/H₂) of the average height (H₁) of the protrusions formed by the first particles to the average height (H₂) of the protrusions formed by the second particles may be, for example, 2.00 or less, more preferably 1.95 or less, and still more preferably 1.90 or less, 1.85 or less, 1.80 or less, 1.75 or less, or 1.70 or less. If the magnetic recording medium has a ratio (H₁/H₂) between the average heights of the protrusions within the above numerical range, a friction increase (PES increase) due to many times of traveling is less likely to occur, resulting in contribution to enabling appropriate maintenance of the polishing force on the magnetic head.

Furthermore, the lower limit of the ratio (H₁/H₂) between the average heights of the protrusions is not particularly limited, and can be, for example, preferably 1.00 or more, more preferably 1.10 or more, and still more preferably 1.20 or more.

The average height (H₁) of the protrusions formed by the first particles may be, for example, 13.0 nm or less, preferably 12.0 nm or less, more preferably 11.5 nm or less, and still more preferably 11.0 nm or less, 10.5 nm or less, 10.0 nm or less, 9.5 nm or less, 9.0 nm or less, or 8.5 nm or less. If the magnetic recording medium has an average height (H₁) of the protrusions formed by the first particles within the above numerical range, the spacing between the magnetic head and the magnetic recording medium is small, and a friction increase due to many times of traveling is less likely to occur, resulting in contribution to enabling appropriate maintenance of the polishing force on the magnetic head.

Furthermore, the lower limit of the average height (H₁) of the protrusions formed by the first particles is not particularly limited, and can be, for example, preferably 5.0 nm or more, more preferably 5.5 nm or more, and still more preferably 6.0 nm or more.

The average height (H₂) of the protrusions formed by the second particles may be, for example, 8.0 nm or less, and is preferably 7.5 nm or less, more preferably 7.0 nm or less, and still more preferably 6.5 nm or less, 6.0 nm or less, 5.5 nm or less, or 5.3 nm or less. If the magnetic recording medium has an average height (H₂) of the protrusions formed by the second particles within the above numerical range, the spacing between the magnetic head and the magnetic recording medium is small, and a friction increase due to many times of traveling is less likely to occur, resulting in contribution to enabling appropriate maintenance of the polishing force on the magnetic head.

Furthermore, the lower limit of the average height (H₂) of the protrusions formed by the second particles is not particularly limited, and can be, for example, preferably 2.0 nm or more, more preferably 2.5 nm or more, and still more preferably 3.0 nm or more.

### (Binder)

As the binder, a resin having a structure in which a crosslinking reaction is imparted to a polyurethane-based resin, a vinyl chloride-based resin, or the like is preferable. However, the binder is not limited thereto, and other resins may be appropriately blended according to a physical property and the like required for the magnetic recording medium 10. The resin to be blended is not particularly limited as long as it is usually used in a coating type magnetic recording medium 10.

Examples of the binder include polyvinyl chloride, polyvinyl acetate, a vinyl chloride-vinyl acetate copolymer, a vinyl chloride-vinylidene chloride copolymer, a vinyl chloride-acrylonitrile copolymer, an acrylic acid ester-acrylonitrile copolymer, an acrylic acid ester-vinyl chloride-vinylidene chloride copolymer, an acrylic acid ester-vinylidene chloride copolymer, a methacrylic acid ester-vinylidene chloride copolymer, a methacrylic acid ester-vinyl chloride copolymer, a methacrylic acid ester-ethylene copolymer, polyvinyl fluoride, a vinylidene chloride-acrylonitrile copolymer, an acrylonitrile-butadiene copolymer, a polyamide resin, polyvinyl butyral, a cellulose derivative (cellulose acetate butyrate, cellulose diacetate, cellulose triacetate, cellulose propionate, or nitrocellulose), a styrene-butadiene copolymer, a polyester resin, an amino resin, synthetic rubber, and the like.

Furthermore, as the binder, a thermosetting resin or a reactive resin may be used, and examples thereof include a phenol resin, an epoxy resin, a urea resin, a melamine resin, an alkyd resin, a silicone resin, a polyamine resin, a urea-formaldehyde resin, and the like.

Furthermore, a polar functional group such as —SO₃M, —OSO₃M, —COOM, P═O(OM)₂, or the like may be introduced into each binder described above in order to improve the dispersibility of the magnetic powder. Here, in the formula, M is a hydrogen atom or an alkali metal such as lithium, potassium, sodium, or the like.

Moreover, examples of the polar functional group include a side chain type having an end group of —NR1R2 or —NR1R2R3⁺X⁻ and a main chain type of >NR1R2⁺X⁻. Here, in the formulae, each of R1, R2, and R3 is a hydrogen atom or a hydrocarbon group, and X⁻ is an ion of a halogen element such as fluorine, chlorine, bromine, iodine, or the like, or an inorganic or organic ion. Furthermore, examples of the polar functional group include OH, —SH, —CN, an epoxy group, and the like.

### (Additive)

The magnetic layer 13 may further contain aluminum oxide (α, β, or γ-alumina), chromium oxide, silicon oxide, diamond, garnet, emery, boron nitride, titanium carbide, silicon carbide, titanium carbide, titanium oxide (rutile type or anatase type titanium oxide), or the like, as non-magnetic reinforcing particles.

### (Non-Magnetic Layer (Underlayer))

The non-magnetic layer (underlayer) 12 is a non-magnetic layer containing a non-magnetic powder and a binder as main components. The description regarding the binder contained in the magnetic layer 13 also applies to the binder contained in the non-magnetic layer 12. The non-magnetic layer 12 may further contain at least one additive of the first particles, a lubricant, a curing agent, a corrosion inhibitor, or the like, as needed.

The average thickness of the non-magnetic layer 12 can be preferably 1.2 μm or less, more preferably 1.0 μm or less, 0.9 μm or less, 0.8 μm or less, or 0.7 μm or less, and still more preferably 0.6 μm or less. Furthermore, the lower limit of the average thickness of the non-magnetic layer 12 is not particularly limited, and is preferably 0.2 μm or more, and more preferably 0.3 μm or more.

### (Non-Magnetic Powder)

The non-magnetic powder contained in the non-magnetic layer 12 can contain, for example, at least one selected from inorganic particles and organic particles. One kind of non-magnetic powder may be used alone, or two or more kinds of non-magnetic powders may be used in combination. The inorganic particles include, for example, one or a combination of two or more selected from metals, metal oxides, metal carbonates, metal sulfates, metal nitrides, metal carbides, and metal sulfides. More specifically, the inorganic particles can be, for example, one or two or more selected from iron oxyhydroxide, hematite, titanium oxide, and carbon black. Examples of a shape of the non-magnetic powder include various shapes such as a needle shape, a spherical shape, a cubic shape, a plate shape, and the like, but are not particularly limited thereto.

### (Back Layer)

The back layer 14 can contain a binder and a non-magnetic powder. The back layer 14 may contain various additives such as a lubricant, a curing agent, an antistatic agent, and the like, as needed. The descriptions regarding the binder and the non-magnetic powder contained in the above-described non-magnetic layer 12 also apply to the binder and the non-magnetic powder contained in the back layer 14.

The average particle size of the inorganic particles contained in the back layer 14 is preferably 10 nm or more and 150 nm or less, and more preferably 15 nm or more and 110 nm or less. The average particle size of the inorganic particles is determined in a manner similar to that for determination of the average particle size D of the magnetic powder described above.

The average thickness t_{b} of the back layer 14 can be preferably 0.6 μm or less, more preferably 0.5 μm or less, and still more preferably 0.4 μm or less, 0.3 μm or less, 0.25 μm or less, or 0.2 μm or less. If the average thickness t_{b} of the back layer 14 is within the above range, even in a case where the average thickness (average total thickness) t_{T} of the magnetic recording medium 10 is t_{T}≤5.7 μm, the average thicknesses of the non-magnetic layer 12 and the base layer 11 can be kept thick, and thus the traveling stability of the magnetic recording medium 10 in a recording and reproducing apparatus can be maintained. Furthermore, the lower limit of the average thickness of the back layer is not particularly limited, and can be, for example, 0.1 μm or more, and preferably 0.15 μm or more.

### (3) Physical Properties and Structure

### (Average Magnetic Cluster Size)

The average magnetic cluster size of the magnetic recording medium according to the present technology is, for example, 1850 nm² or less, more preferably 1800 nm² or less, and still more preferably 1750 nm² or less, 1700 nm² or less, 1650 nm² or less, or 1600 nm^{z} or less, and may be 1550 nm² or less or 1500 nm^{z} or less. The average magnetic cluster size of the magnetic layer of the magnetic recording medium according to the present technology is as small as described above, that is, the surface recording density is high.

The lower limit of the average magnetic cluster size may be not particularly limited, or may be, for example, 500 nm² or more, preferably 600 nm² or more, and more preferably 700 nm² or more, 800 nm² or more, 900 nm² or more, or 1000 nm² or more. If the average magnetic cluster size is set to these values or more, the thermal stability of the magnetic recording medium is improved.

The average magnetic cluster size is measured on the basis of an MFM image of the magnetic layer side surface of the magnetic recording medium. The measurement method is as follows.

First, for example, a magnetic recording medium accommodated in a cartridge such as a cartridge 10A described below is unwound, a range where data is recorded in the magnetic recording medium is cut out in a 1 cm×1 cm square at a position 20 m from the outside of the cartridge in the longitudinal direction, and the cut-out part is used as a measurement sample.

The magnetic layer side surface of the measurement sample is subjected to a DC erase process. The DC erase process is performed using a vibrating sample magnetometer (VSM). The VSM may be a high-sensitivity vibrating sample magnetometer model VSM-P7-15 manufactured by Toei Industry Co., Ltd.

The measurement sample is set in the VSM so that the magnetic surface of the measurement sample is in a direction parallel to an opposing coil of the VSM. Then, an external magnetic field of 15 kOe in the vertical direction is applied to the magnetic surface. Thereafter, the external magnetic field is turned off, and the sample subjected to the DC erase process is acquired. In this manner, the DC erase process is performed.

Next, a central part of the sample subjected to the DC erase process is cut in a 5 mm×5 mm square. The cut-out part is observed using a magnetic force microscope (hereinafter also referred to as MFM), three different portions are randomly selected from the cut-out part, and an MFM image of each of the three portions is obtained. In this way, three MFM images are obtained.

As an MFM for obtaining the MFM images, NanoScopeIV Dimension3100 manufactured by Digital Instruments and its analysis software are used. Furthermore, as the cantilever for the MFM, SSS-MFMR (manufactured by NANOSENSORS, probe material: silicon single crystal coated with a magnetic film, cantilever length: 225 μm, tuned at 0-150 Hz) is used. Measurement conditions of the MFM are as follows.

### <Measurement Conditions>

Scan size: 5 μm×5 μm
Number of sample: 512×512
Phase detection mode
Lift height: 20 nm
Filtering process
Flatten order: 2
Planefit order XY: 3
Sweep speed: 1 Hz

That is, the measurement region for obtaining the MFM image is a 5 μm×5 μm measurement region, and the 5 μm×5 μm measurement region is divided into 512×512 (=262,144) measurement points. The 5 μm×5 μm measurement region is measured with the MFM under the above-described measurement conditions, and an MFM image is obtained.

Each of the obtained three MFM images is subjected to image analysis processing described below to obtain three magnetic cluster size values. The three magnetic cluster size values are simply averaged, and thus the average magnetic cluster size is obtained.

The image analysis processing is performed as follows using image analysis software ImageJ (available from National Institutes of Health). In parentheses for each of the following steps, a specific operation procedure of the software is shown. Note that the image analysis processing can also be said to measure the particle size distribution of magnetic clusters, that is, can also be said to be grain size analysis.

### Step 1: Data Reading (“File”→“Open”)

An image file of an MFM image to be subjected to image analysis is opened.

### Step 2: Scale Setting (“Analyze”→“Set Scale”)

In the Set Scale window, the scale is set as follows.
Distance in pixels: 512
Known distance: 5
Pixel aspect ratio: 1.0
Unit of length: um

After the setting, the OK button in the window is clicked.

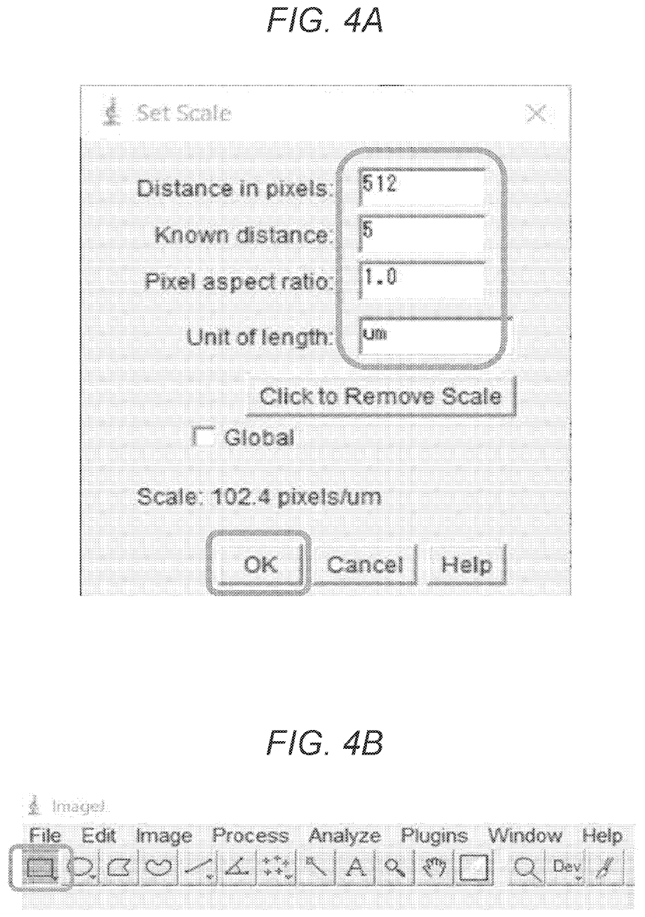

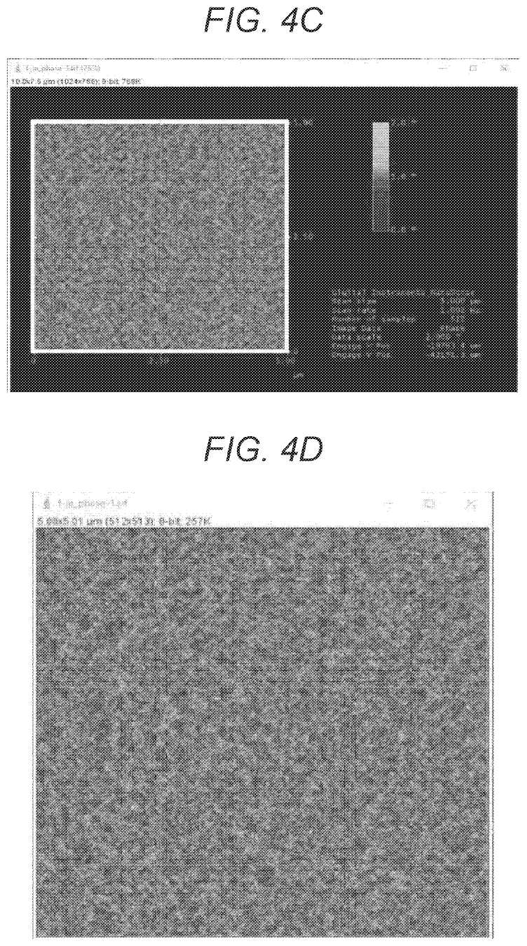

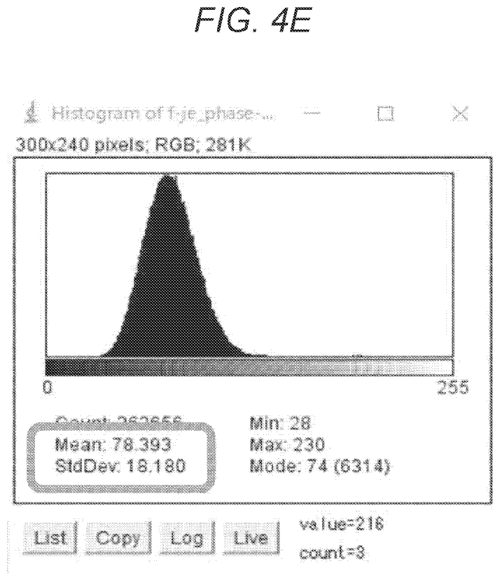

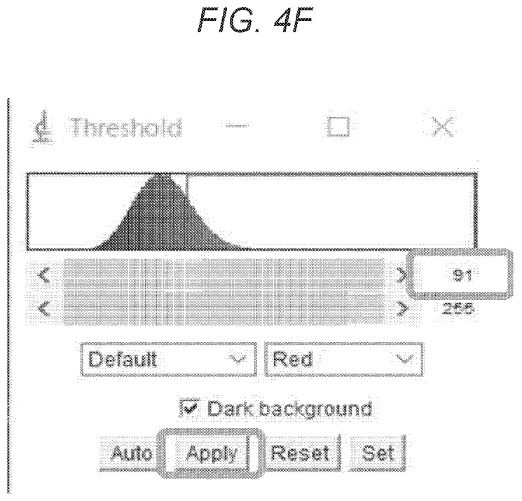

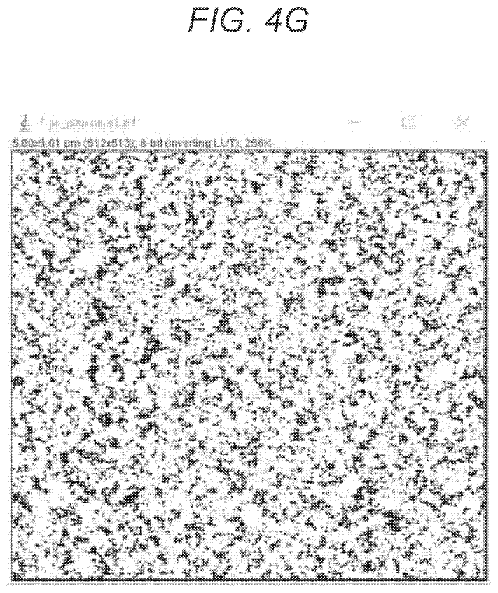

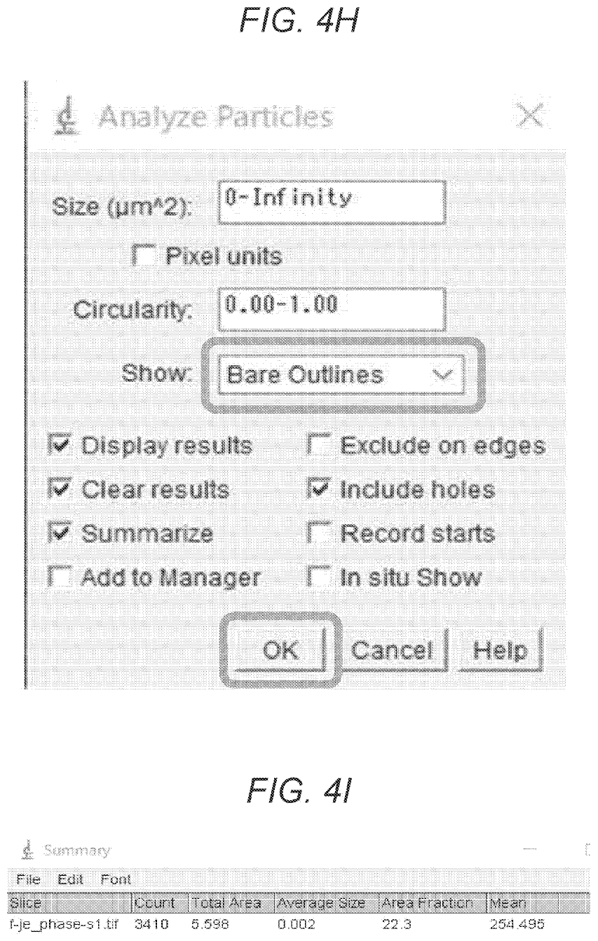

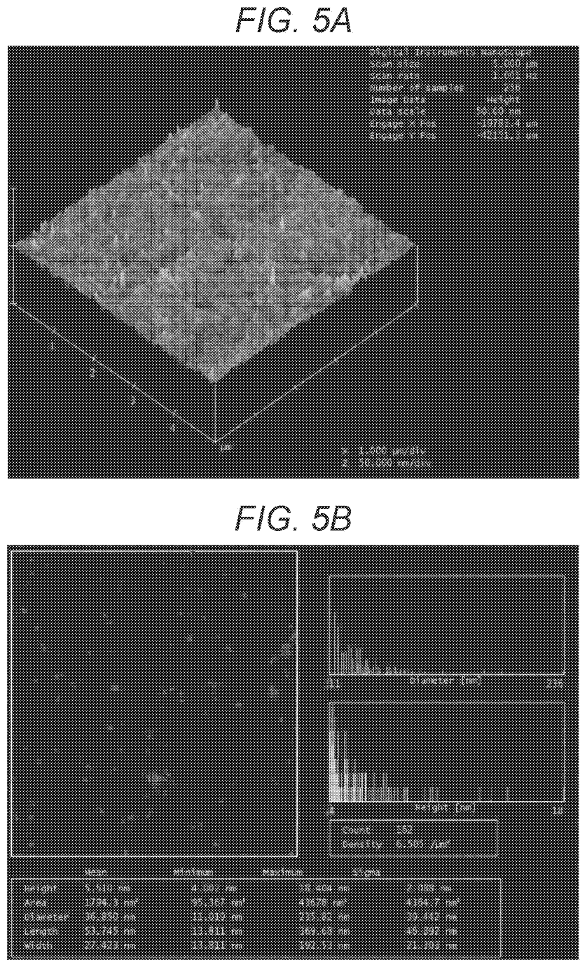

For example, as shown in FIG. 4A, an input to the Set Scale window is performed, and then the OK button in the window is clicked.

Step 3: Measurement Image Cutting (“Rectangle” in “Area Selection Tools”→Surrounding of MFM image→“Image”→“Crop”)

Using the rectangle selection tool, the MFM image is selected so as to be surrounded. The selected range is cut out.

For example, as shown in FIG. 4B, the rectangle selection tool is selected, then as shown by the white line in FIG. 4C, the MFM image is selected to be surrounded by a rectangle, and then cut out, and thus a window for displaying the cut-out MFM image is generated as shown in FIG. 4D.

Step 4: Image type conversion (“Image”→“Type”→“8-bit”)

The image type of the image cut out in Step 3 is converted into an 8-bit grayscale image.

Step 5: Image smoothing (“Process”→“Smooth”)

The image converted into an 8-bit grayscale image in Step 4 is subjected to smoothing to remove noise.

### Step 6: Saving (“Save”)

The image after the noise removal in Step 5 is given an arbitrary name and stored in the TIF format.

Step 7: Histogram generation (“Analyze”→“Histogram”)

A histogram of the image stored in Step 6 is generated. As a result, the Mean value and the StdDev. value are displayed in the histogram window.

For example, the histogram window shown in FIG. 4E is displayed, and in the window, the Mean value and the StdDev. value are displayed.

### Step 8: Threshold Setting (“Image”→“Adjust”→“Threshold”)

Using the Mean value and the StdDev. value displayed in Step 7, a threshold is determined with the following formula. Note that the distribution in the histogram is assumed to be Gaussian (normal) distribution. Furthermore, the standard deviation (StdDev. value) is the root mean square value (rms).

[Threshold value]=[Mean]+([StdDev.]×0.7)

In the Threshold window, the determined threshold is input as the minimum value (Min) and 255 is input as the maximum value (Max), and the “Apply” button is clicked. As a result of the click, a binary image is displayed.

That is, the threshold range a for binarization is set to satisfy

$$\{ [ Mean ] + ( [ StdDev . ] \times 0.7 ) \} \leq a \leq 255$$

and thus the average area of the positive electrode part in the image is calculated.

For example, the determined threshold is input in the minimum value (Min) input field in the Threshold window shown in FIG. 4F, and the “Apply” button is clicked for the maximum value. As a result, a binarized image as shown in FIG. 4G is obtained.

### Step 9: Particle Size Distribution Calculation (“Analyze”→“Analyze Particles”)

The binarized image obtained in Step 8 is subjected to particle size distribution calculation processing. Processing conditions in the calculation processing are as follows.
Size: 0-Infinity
Circularity: 0.00-1.00
Show: Bare outlines

In the Analyze Particles window, Summarize is checked, and thus the Summary screen is displayed. On the Summary screen, Count (the number of particles), Total Area (the total of the area), Average size (the number of particles), Area Function (the ratio of the area occupied by particles), and Mean (the average) are displayed. Among them, [Count] and [Total Area] are used to calculate the average magnetic cluster size with the following formula.

[Magnetic cluster size value (nm²)]=[Total Area]/[Count]×10⁶

For example, as shown in FIG. 4H, setting in the Analyze Particles window is performed, and the OK button is clicked. As a result, the Summary screen as shown in FIG. 4I is displayed. The magnetic cluster size value is calculated using data on the screen.

Each of the three MFM images is subjected to the above-described image analysis processing to obtain three magnetic cluster size values. The three magnetic cluster size values are simply averaged, and thus the average magnetic cluster size is obtained.

### (Height of Protrusion)

As described below, the height of the protrusion formed by each of the first particles and the second particles is measured by, in the same site of the measurement sample, performing shape analysis with an atomic force microscope (hereinafter, referred to as AFM) and performing component discrimination by image analysis using a luminance difference due to a difference in the amount of secondary electron emission between the first particles and the second particles in the FE-SEM image imaged with a field emission scanning electron microscope (hereinafter, referred to as FE-SEM). That is, the height of each protrusion can be measured with the AFM, and which of a first particle or a second particle has formed each protrusion can be specified by the FE-SEM. The image obtained by the AFM and the image obtained by the FE-SEM in the certain region are superimposed for the same site to obtain a composite image, and from the obtained composite image, the kind of a particle forming each protrusion (whether the particle is the first particle or the second particle) and the height of each protrusion can be made correspond to each other.

Hereinafter, a method of measuring the height of a protrusion using an AFM, a method of specifying the kind of a particle forming a protrusion using a FE-SEM, and a method of making the height of a protrusion and the kind of the particle forming the protrusion correspond to each other will be described.

### (Method of Measuring Height of Protrusion Using Atomic Force Microscope (AFM))

In the present technology, the height of a protrusion formed by each of the first particles and the second particles is determined as follows.

First, a measurement sample is prepared by cutting out, in a size such that the measurement sample can be placed on a sample stage for FE-SEM observation described below, from the magnetic recording medium 10 in a user data area (for example, 24 m or more from a reader pin) in an LTO cartridge.

Next, the measurement sample surface excluding the central portion of the measurement sample is marked. As the marking method, a method may be employed in which the surface of the magnetic recording medium 10 is scratched with a needle-shaped metal marker using a manipulator. Note that in an AFM, the marked portion is scanned with a probe, and therefore the probe tip may be contaminated and an accurate shape image may be not obtained according to the state of the marked portion, so that the marking is preferably small and shallow so as not to contaminate the probe.

Next, the visual field near the marked portion on the measurement sample surface is subjected to shape analysis with an AFM. Since the marked portion with the marking is recessed, alignment is performed so that the marked portion is as close as possible to the edge of the visual field, and then measurement is performed at a viewing angle of 5 μm×5 μm with the AFM. Note that protrusions in the surrounding portion of the marked portion are not to be measured. As a specific procedure for the shape analysis, for example, a viewing angle of 10 μm×10 μm including the marked portion is first measured, a part as a mark is determined and alignment is performed, and then a part excluding the marked portion is measured at a viewing angle of 5 μm×5 μm in accordance with the part as a mark.

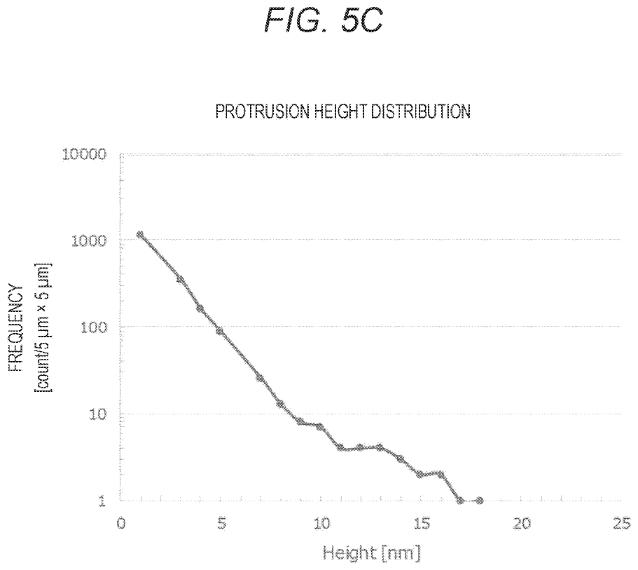

The measurement conditions for the shape analysis are as described below. For each of the first particle and the second particle, in a case where 20 or more particles can be specified in one visual field of the AFM from one measurement sample, the one visual field is measured with the AFM. For each of the first particle and the second particle, in a case where the number of particles that can be specified in one visual field of the AFM is less than 20, a plurality of (for example, 3 to 5) visual fields is measured from one measurement sample. For each of the first particle and the second particle, 20 points specified as particles by binarization processing are secured, the values obtained by measuring the 20 points with the AFM are averaged, and the obtained average value is regarded as the average height of the protrusions (the average height H₁ of the protrusions formed by the first particles and the average height H of the protrusions formed by the second particles). Information regarding the surface shape, the protrusion analysis, and the height distribution of the protrusions can be obtained by the shape analysis. FIG. 5A is an example of an image showing an example of a surface shape imaged with an AFM. FIG. 5B is a view showing an example of a protrusion analysis result by an AFM. FIG. 5C is a view showing an example of protrusion height distribution. From the obtained information, data can be obtained such as the number of protrusions formed, the height of the protrusions formed by the particles, and the like.

### <AFM Measurement Conditions>

Apparatus: AFM Dimension 3100 microscope (with NanoscopeIV controller) (Digital Instruments, USA), measurement mode: tapping
Tapping frequency during tuning: 200 to 400 kHz
Cantilever: SNL-10 (manufactured by Bruker Corporation)
Scan size: 5 μm×5 μm
Scan rate: 1 Hz
Scan line: 256

### <Method of Calculating Reference Plane in Calculating Protrusion Height>

The AFM image is divided into 256×256 (=65,536) measurement points, the height Z(i) (i: measurement point number, i=1 to 65,536) is measured at each measurement point, and the measured heights Z(i) at the measurement points are simply averaged (arithmetically averaged) to determine the average height (reference plane) Zₐᵥₑ (=(Z(1)+Z(2)+ . . . +Z(65,536))/65,536). (“Height at measurement point”−“reference plane height”) corresponds to the height of each protrusion.

### (Method of Specifying Kind of Particle Forming Protrusion Using FE-SEM)

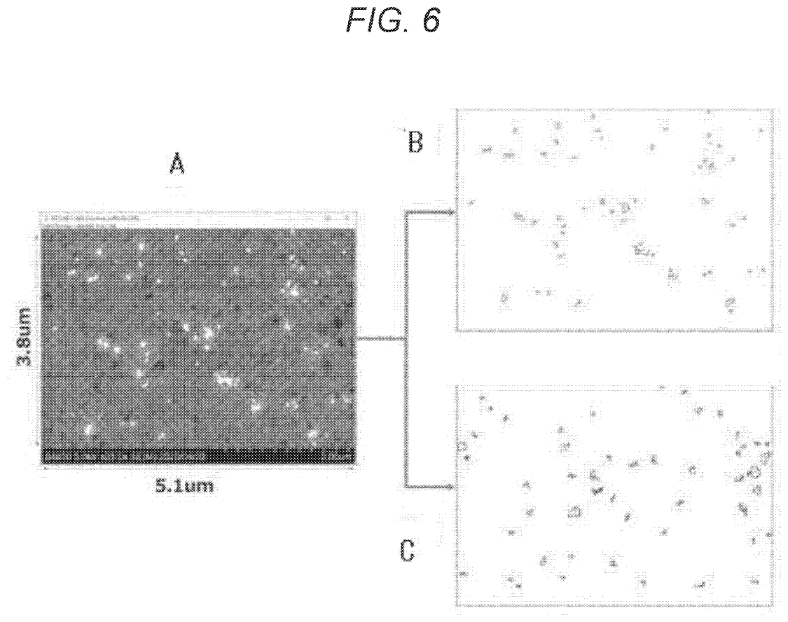

A region including the marked portion of the measurement sample is imaged under the FE-SEM measurement conditions described below using a field emission scanning electron microscope (FE-SEM) to obtain a FE-SEM image. A of FIG. 6 is an example of a FE-SEM image. From the obtained FE-SEM image, the kind of a particle forming a protrusion can be specified using a luminance difference due to a difference in the amount of secondary electron emission between the first particles and the second particles. Image processing for the specification will be described below. Furthermore, the position of a protrusion formed by each of the first particles and the second particles in the FE-SEM image is identified.

### <FE-SEM Measurement Conditions>

Apparatus: HITACHI S-4800 (manufactured by Hitachi High-Technologies Corporation)
Viewing angle: 5.1 μm×3.8 μm
Acceleration voltage: 5 kV
Measurement magnification: 25000 times

The obtained FE-SEM image (A of FIG. 6) is subjected to binarization processing under each of two processing conditions described below using image processing software ImageJ. From the image obtained by the binarization processing, information is obtained regarding the number of protrusions formed by particles for each of the first particle and the second particle, the average area of one protrusion, the total area of the protrusions, and the diameter of the protrusion (Feret diameter).

Furthermore, the number of protrusions per unit area can be calculated for each of the first particle and the second particle with the following calculation formula.

[Number of protrusions per unit area]=[number of protrusions]÷[area of region for which this number of protrusions is acquired]

In the calculation formula, the number of protrusions can be automatically acquired with image processing software ImageJ.

Note that, in the binarization processing, the conditions are changed as follows between the second particles having a high luminance (the white portions in A of FIG. 6) and the first particles having a low luminance (the black portions in A of FIG. 6).

### <Binarization Processing Conditions for Obtaining Information Regarding First Particles>

Software: ImageJ Ver 1.44p
Binarization threshold value: Threshold (0.65)
Binarization target size: 0.002 μm-infinity

### <Binarization Processing Conditions for Obtaining Information Regarding Second Particles>

Software: ImageJ Ver 1.44p
Binarization threshold value: Threshold (220,255)
Binarization target size: 0.001 μm-infinity

B of FIG. 6 is an image showing positional distribution of protrusions formed by the second particles (alumina particles), obtained by binarizing the FE-SEM image of A of FIG. 6 under the binarization processing conditions for the second particles (alumina particles). For example, regarding FIG. 6, the following information regarding the second particles was obtained from the obtained image.

### <Obtained Information Regarding Second Particles>

Number: 58
Average area: 0.003 μm²
Total area: 0.198 μm²
Feret diameter: 0.091 μm

C of FIG. 6 is an image showing positional distribution of protrusions formed by the first particles (carbon black particles), obtained by binarizing the FE-SEM image of A of FIG. 6 under the binarization processing conditions for the first particles (carbon black particles). For example, regarding FIG. 6, the following information regarding the first particles was obtained from the obtained image.

### <Obtained Information Regarding First Particles>

Number: 55
Average area: 0.005 μm²
Total area: 0.262 μm²
Feret diameter: 0.013 μm

### (Method of Making Height of Protrusion and Kind of Particle Forming Protrusion Correspond to Each Other)

The obtained AFM image and the FE-SEM image before the binarization processing are superimposed to obtain a composite image. The composited image is used for specifying which of a first particle or a second particle has formed each protrusion.

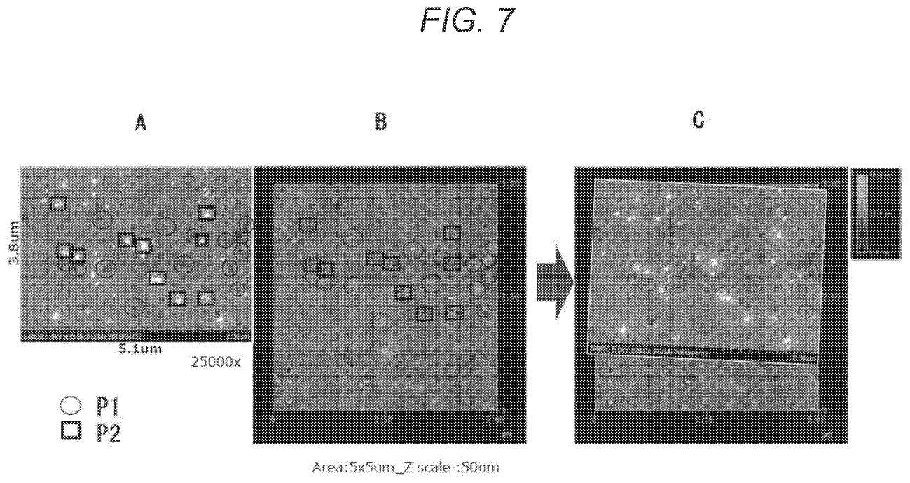

For example, C of FIG. 7 is a composite image obtained by superimposing an AFM image (B of FIG. 7) and a FE-SEM image (A of FIG. 7) so that respective positions of corresponding protrusions coincide with each other. In FIG. 7, in the FE-SEM image before image compositing (A of FIG. 7), the position of a protrusion formed by a first particle P1 and the position of a protrusion formed by a second particle P2, which are discriminated by the binarization processing, are marked with different marks so that the respective positions can be discriminated. Similarly, in the AFM image before image compositing (B of FIG. 7), the position of a protrusion formed by a first particle (carbon black particle) P1 and the position of a protrusion formed by a second particle (alumina particle) P2, which are discriminated by the binarization processing, are marked with different marks so that the respective positions can be discriminated. The AFM image (B of FIG. 7) and the FE-SEM image (A of FIG. 7) are superimposed so that the respective positions of corresponding protrusions coincide with each other to obtain a composite image, and from the composite image, which of the first particle P1 or the second particle P2 has formed each protrusion is discriminated. Note that in B of FIG. 7, no marking is present in the image because the marked portion is measured at a viewing angle of 10 μm×10 μm with the AFM and then a part with no marking is measured at a viewing angle of 5 μm×5 μm.

Next, the height of each protrusion in the composite image is measured using AFM analysis software (Software version 5.12 Rev. B for Dimension 3100, manufactured by Veeco Instruments Inc.). For each protrusion, the kind of the particle forming the protrusion (whether the particle is the first particle or the second particle) is specified as described above, and therefore the specified kind of the particle can be made correspond to the measured height.

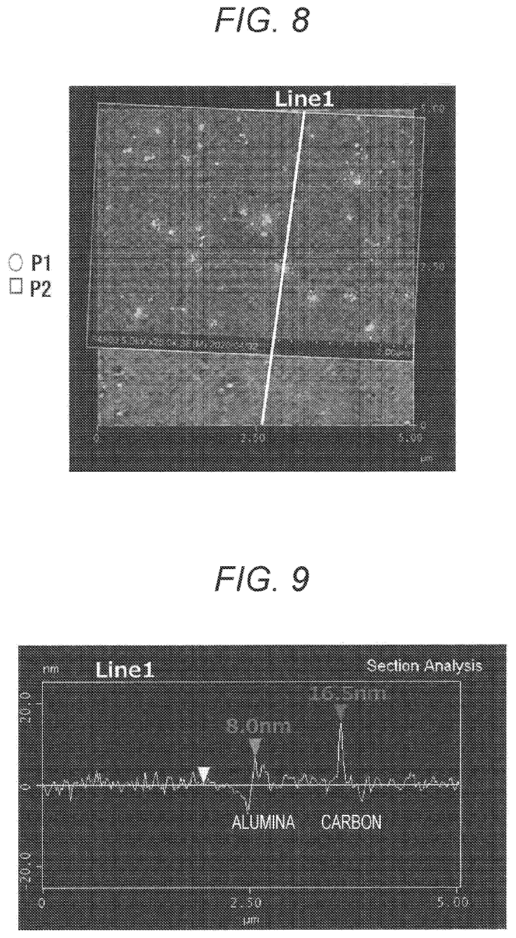

For example, FIG. 8 is an enlarged view of a composite image in which an AFM image and a FE-SEM image are superimposed. FIG. 9 is a view showing an analysis result by an AFM (measurement result of the protrusion height) for the line 1 (Line1) set at an arbitrary position in FIG. 8. As shown in FIG. 9, the height of the protrusion formed by each of the first particle (carbon black particle) and the second particle (alumina particle) present on the line 1 can be specified. In this manner, the height of each protrusion is specified from the composite image and the AFM analysis result.

### (Average Height of Protrusions and Ratio Between Average Heights of Protrusions)

From the information regarding the heights of the protrusions obtained as described above, the average height of the protrusions formed by the first particles, the average height of the protrusions formed by the second particles, and the ratio between the average heights of the protrusions are determined as described above.

### (Average Thickness (Average Total Thickness) t_{T} of Magnetic Recording Medium)

The average thickness (average total thickness) t_{T} of the magnetic recording medium 10 may be, for example, 5.7 μm or less, preferably 5.6 μm or less, more preferably 5.5 μm or less, 5.4 μm or less, 5.3 μm or less, 5.2 μm or less, 5.1 μm or less, or 5.0 μm or less, and still more preferably 4.6 μm or less or 4.4 μm or less. If the average thickness t_{T} of the magnetic recording medium 10 is 5.2 μm or less, the recording capacity for recording in one data cartridge can be larger than that of a general magnetic tape. The lower limit of the average thickness t_{T} of the magnetic recording medium 10 is not particularly limited, and is, for example, 3.5 μm or more.

The average thickness t_{T} of the magnetic recording medium 10 (hereinafter, also referred to as magnetic tape T) is determined as follows. First, for example, a magnetic tape T accommodated in a cartridge such as the cartridge 10A described below is unwound, and the magnetic tape T is cut out in a length of 250 mm at a position 30 m from a connection portion 221 between the magnetic tape T and a leader tape LT in the longitudinal direction to prepare a sample. Next, the thickness of the sample is measured at five positions using a laser hologauge (LGH-110C) manufactured by Mitutoyo Corporation as a measuring apparatus, and these measured values are simply averaged (arithmetically averaged) to calculate the average thickness t_{T} [μm]. Note that the five measurement positions are randomly selected from the sample so as to be different positions in the longitudinal direction of the magnetic tape T.

### (Average Thickness of Non-Magnetic Layer (Underlayer))

The average thickness of the non-magnetic layer 12 can be determined as follows. First, for example, a magnetic tape T accommodated in a cartridge such as the cartridge 10A described below is unwound, and the magnetic tape T is cut out in a length of 250 mm at each of three positions 10 m, 30 m, and 50 m, respectively, from a connection portion 221 between the magnetic tape T and a leader tape LT in the longitudinal direction to prepare three samples. Subsequently, each sample is processed with a FIB method or the like to perform thinning. In a case where the FIB method is used, formation of a carbon layer and a tungsten layer as protective films is performed as pre-processing for observing a TEM image of a cross section described below. The carbon layer is formed on a magnetic layer 13 side surface and a back layer 14 side surface of the magnetic tape T with a vapor deposition method, and then the tungsten layer is further formed on the magnetic layer 13 side surface with a vapor deposition method or a sputtering method. The thinning is performed in the longitudinal direction of the magnetic tape T. That is, a cross section parallel to both the longitudinal direction and the thickness direction of the magnetic tape T is formed by the thinning.

The above-described obtained cross section of each thinned sample is observed with a transmission electron microscope (TEM) under the following conditions.
Apparatus: TEM (H9000NAR manufactured by Hitachi, Ltd.)
Acceleration voltage: 300 kV
Magnification: 100,000 times

Next, the thickness of the non-magnetic layer 12 is measured at least 10 positions in the longitudinal direction of the magnetic tape T using the obtained TEM image, and then these measured values are simply averaged (arithmetically averaged) to obtain the average thickness (μm) of the non-magnetic layer 12.

### (Average Thickness of Base Layer)

The average thickness of the base layer 11 can be determined as follows. First, for example, a magnetic tape T accommodated in a cartridge such as the magnetic recording cartridge 10A described below is unwound, and the magnetic tape T is cut out in a length of 250 mm at a position 30 m from a connection portion 221 between the magnetic tape T and a leader tape LT in the longitudinal direction to prepare a sample. In the present description, the “longitudinal direction” in the case of “longitudinal direction from a connection portion between a magnetic tape T and a leader tape LT” means a direction from one end on the leader tape LT side toward the other end on the opposite side.

Subsequently, layers other than the base layer 11 of the sample (that is, the non-magnetic layer (underlayer) 12, the magnetic layer 13, and the back layer 14) are removed with a solvent such as methyl ethyl ketone (MEK), dilute hydrochloric acid, or the like. Next, the thickness of the sample (base layer 11) is measured at five positions using a laser hologauge (LGH-110C) manufactured by Mitutoyo Corporation as a measuring apparatus, and these measured values are simply averaged (arithmetically averaged) to calculate the average thickness of the base layer 11. Note that the five measurement positions are randomly selected from the sample so as to be different positions in the longitudinal direction of the magnetic tape T.

### (Average Thickness to of Back Layer)

The upper limit of the average thickness of the back layer 14 is preferably 0.6 μm or less. If the upper limit of the average thickness of the back layer 14 is 0.6 μm or less, the thicknesses of the non-magnetic layer (underlayer) 12 and the base layer 11 can be kept thick even in a case where the average thickness of the magnetic tape T is 5.6 μm or less, so that the traveling stability of the magnetic tape T in a recording and reproducing apparatus can be maintained. The lower limit of the average thickness of the back layer 14 is not particularly limited, and is, for example, 0.2 μm or more.

The average thickness t_{b} of the back layer 14 is determined as follows. First, the average thickness (average total thickness) t_{T} of the magnetic tape T is measured. The method of measuring the average thickness t_{T} (average total thickness) is as described above. Subsequently, the magnetic tape T accommodated in the cartridge 10A is unwound, and the magnetic tape T is cut out in a length of 250 mm at a position 30 m from the connection portion 221 between the magnetic tape T and the leader tape LT in the longitudinal direction to prepare a sample. Next, the back layer 14 of the sample is removed with a solvent such as methyl ethyl ketone (MEK), dilute hydrochloric acid, or the like. Next, the thickness of the sample is measured at five positions using a laser hologauge (LGH-110C) manufactured by Mitutoyo Corporation, and these measured values are simply averaged (arithmetically averaged) to calculate the average t_{B} [μm]. Thereafter, the average thickness t_{b} [μm] of the back layer 14 is determined with the following formula. Note that the five measurement positions are randomly selected from the sample so as to be different positions in the longitudinal direction of the magnetic tape T.

$${t}_{b} [ μ m ] = {t}_{T} [ μ m ] - {t}_{B} [ μ m ]$$

### (Average Thickness tₘ of Magnetic Layer)

The average thickness tₘ, of the magnetic layer 13 is determined as follows. First, the magnetic tape T accommodated in the cartridge 10A is unwound, and the magnetic tape T is cut out in a length of 250 mm at each of three positions 10 m, 30 m, and 50 m, respectively, from the connection portion 221 between the magnetic tape T and the leader tape LT in the longitudinal direction to prepare three samples. Subsequently, each sample is processed with a FIB method or the like to perform thinning. In a case where the FIB method is used, formation of a carbon layer and a tungsten layer as protective films is performed as pre-processing for observing a TEM image of a cross section described below. The carbon layer is formed on a magnetic layer 13 side surface and a back layer 14 side surface of the magnetic tape T with a vapor deposition method, and then the tungsten layer is further formed on the magnetic layer 13 side surface with a vapor deposition method or a sputtering method. The thinning is performed in the longitudinal direction of the magnetic tape T. That is, a cross section parallel to both the longitudinal direction and the thickness direction of the magnetic tape T is formed by the thinning.

The above-described obtained cross section of each thinned sample is observed with a transmission electron microscope (TEM) under the following conditions, and thus a TEM image of each thinned sample is obtained. Note that the magnification and the acceleration voltage may be appropriately adjusted according to the type of the apparatus.
Apparatus: TEM (H9000NAR manufactured by Hitachi, Ltd.)
Acceleration voltage: 300 kV
Magnification: 100,000 times

Next, the thickness of the magnetic layer 13 is measured at 10 positions of each thinned sample using the obtained TEM image of each thinned sample. Note that the 10 measurement positions of each thinned sample are randomly selected from the sample so as to be different positions in the longitudinal direction of the magnetic tape T. The average obtained by simply averaging (arithmetically averaging) the obtained measured values of the thinned samples (the thicknesses of the magnetic layer 13 at 30 points in total) is regarded as the average thickness tₘ [nm] of the magnetic layer 13.

### (Standard Deviation σPES of PES Value)

The standard deviation σPES of the PES value of the magnetic recording medium 10 according to the present technology is such that when a full volume test is performed 40 times, the σPES may be preferably 50 nm or less, preferably less than 50 nm, more preferably 40 nm or less, still more preferably 30 nm or less, and still more preferably 25 nm or less. In the present description, the number of full volume tests is also referred to as the FV number.

When a servo pattern is reproduced (read) by a recording and reproducing apparatus 30, the position error signal (PES) indicates the deviation amount (error) of the reading position of the servo pattern in the width direction of the magnetic recording medium 10. In order to accurately adjust the tension of the magnetic recording medium 10 in the longitudinal direction, it is preferable that when the servo pattern is read by the recording and reproducing apparatus 30, the linearity of the servo band be as high as possible, that is, the standard deviation σPES of the PES value indicating the deviation amount of the reading position be as low as possible. If the standard deviation σPES of the PES value of the magnetic recording medium 10 of the present technology is a low value as described above, the linearity of the servo band is high, and tension adjustment can be performed with high accuracy.

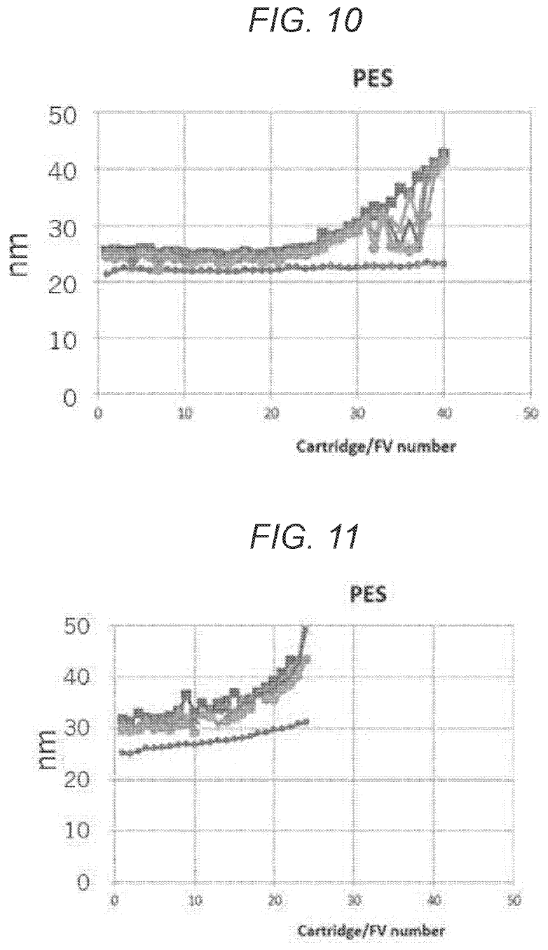

FIG. 10 is a view illustrating a temporal change of the standard deviation σPES of the PES value accompanying traveling of a magnetic tape. As illustrated in FIG. 10, when the full volume test is performed 40 times, if the σPES is less than 50 nm, no track shift occurs. FIG. 11 is a view illustrating a temporal change of the standard deviation σPES of the PES value accompanying traveling of a magnetic tape. As illustrated in FIG. 11, when the full volume test is performed 40 times, if the σPES is more than 50 nm, track shift frequently occurs, and thus traveling of the magnetic tape stops.

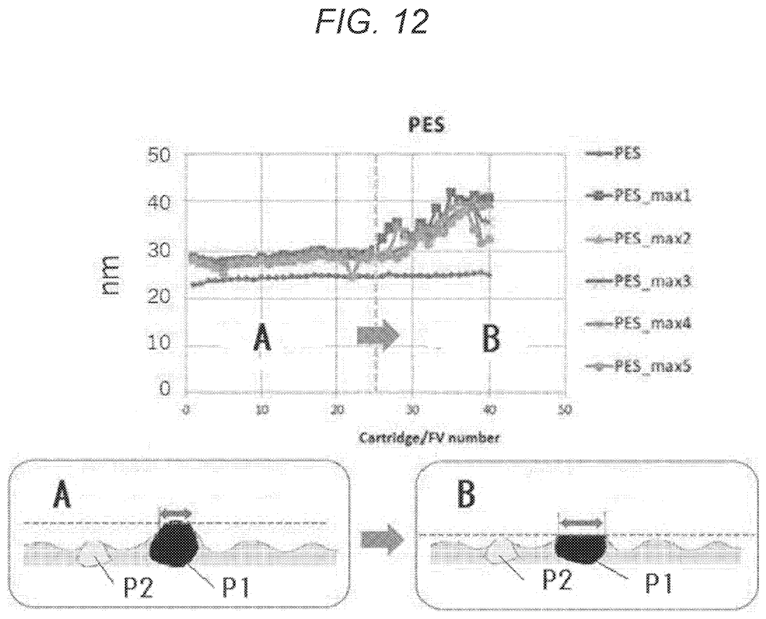

The upper view of FIG. 12 is a view illustrating a temporal change of the standard deviation σPES accompanying traveling of a magnetic tape. The lower left view of FIG. 12 is a cross-sectional view schematically illustrating a relationship among a protrusion formed by a first particle (carbon particle) P1 on a magnetic layer surface, a protrusion formed by a second particle (alumina particle) P2 on the magnetic layer surface, and a magnetic head in a region A where the σPES in the upper view is substantially a constant value (the friction is stable). The broken line in this view is an imaginary line indicating contact between the protrusion formed by the first particle (carbon particle) P1 and the magnetic head surface. The lower right view of FIG. 12 is a cross-sectional view schematically illustrating a relationship among the protrusion formed by the first particle (carbon particle) P1 on the magnetic layer surface, the protrusion formed by the second particle (alumina particle) P2 on the magnetic layer surface, and the magnetic head in a region B where the σPES in the upper view tends to increase (the friction increases). The broken line in this view is an imaginary line indicating contact between the protrusion formed by the first particle (carbon particle) P1 and the magnetic head surface.

As illustrated in FIG. 12, it is presumed that the reason why, while the standard deviation σPES is substantially constant in the region A, the standard deviation σPES increases in the region B is that while, in the region A, the contact area between the protrusion formed by the first particle (carbon particle) P1 and the magnetic head surface is small and the friction is constant, as the magnetic tape travels in the region B, the first particle (carbon particle) P1 is worn by the magnetic tape, the protrusion formed by the first particle (carbon particle) P1 gradually collapses, the contact area between the protrusion formed by the first particle (carbon particle) P1 and the magnetic head surface increases, and the friction increases.

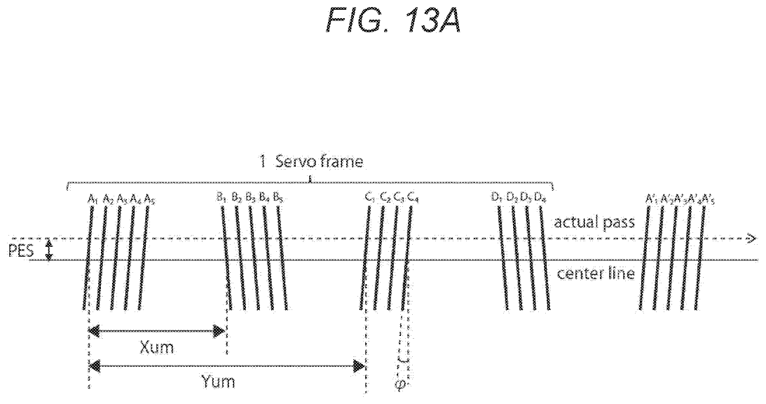

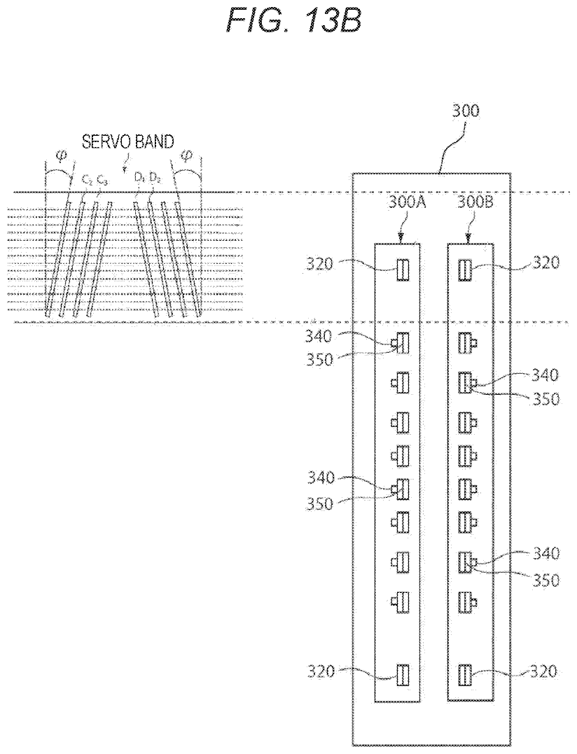

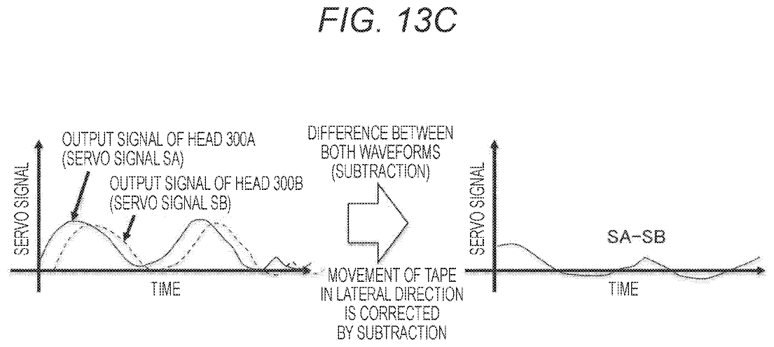

Hereinafter, a method of measuring the standard deviation σPES will be described with reference to FIGS. 13A to 13C.

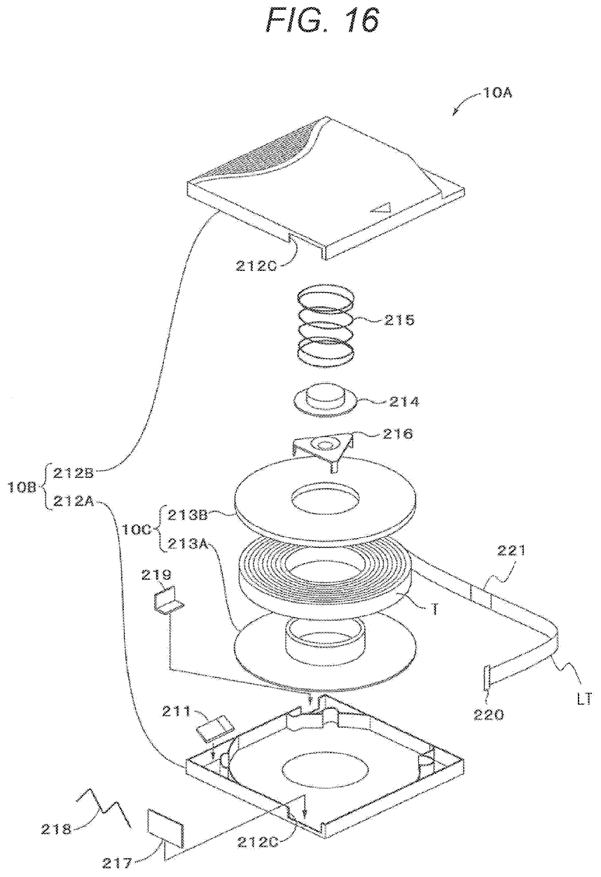

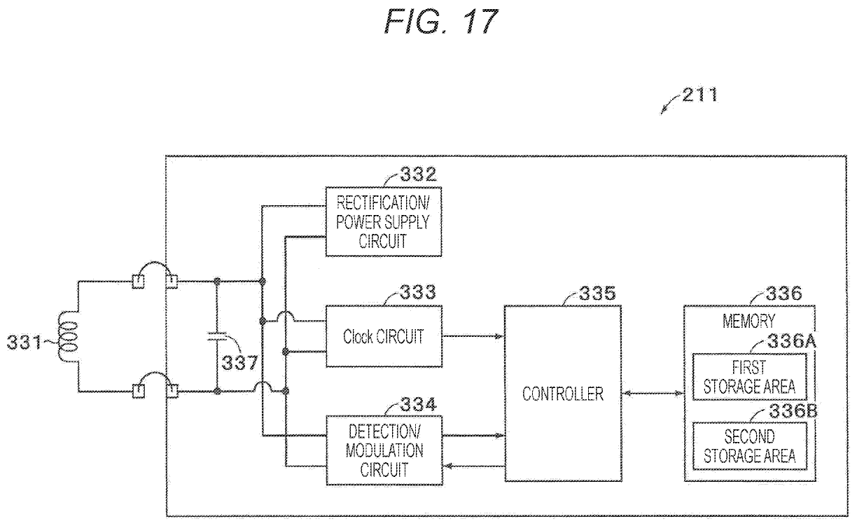

A PES value is measured to determine the standard deviation σPES. For measurement of the PES value, for example, a PES measurement head unit 300 illustrated in FIG. 16B is prepared. As the head unit 300, an LTO2 head (head conforming to the LTO2 standard) manufactured by Hewlett Packard Enterprise (HPE) is used. The head unit 300 includes two head portions 300A and 300B arranged side by side along the longitudinal direction of the magnetic recording medium 10. Each head portion includes a plurality of recording heads 340 for recording data signals in a magnetic recording medium 10, a plurality of reproducing heads 350 for reproducing the data signals recorded in the magnetic recording medium 10, and a plurality of servo heads 320 for reproducing the servo signals recorded in the magnetic recording medium 10. Note that in a case where the head unit 300 is used only for measuring the PES value, the recording head 340 and the reproducing head 350 may be not included in the head unit.

First, servo patterns in a predetermined servo band provided in the magnetic recording medium 10 are reproduced (read) using the head unit 300. At this time, the servo head 320 of the head portion 300A and the servo head 320 of the head portion 300B sequentially face the servo patterns of the predetermined servo band, and these two servo heads 320 sequentially reproduce the servo patterns. At this time, a part, in the servo pattern recorded in the magnetic recording medium 10, facing the servo head 320 is read and output as a servo signal.

As illustrated in FIG. 13A, the PES value for each head portion is calculated for each servo frame with the following calculation formula.

$$PES [ μ m ] = \frac{X [ μ m ] - [ \frac{( {B}_{a 1} - {A}_{a 1} ) + ( {B}_{a 2} - {A}_{a 2} ) + ( {B}_{a 3} - {A}_{a 3} ) + ( {B}_{a 4} - {A}_{a 4} ) + ( {D}_{a 1} - {C}_{a 1} ) + ( {D}_{a 2} - {C}_{a 2} ) + ( {D}_{a 3} - {C}_{a 3} ) + ( {D}_{a 4} - {C}_{a 4} )}{( {C}_{a 1} - {A}_{a 1} ) + ( {C}_{a 2} - {A}_{a 2} ) + ( {C}_{a 3} - {A}_{a 3} ) + ( {C}_{a 4} - {A}_{a 4} ) + ( {A}_{a 1}^{′} - {C}_{a 1} ) + ( {A}_{a 2}^{′} - {C}_{a 2} ) + ( {A}_{a 3}^{′} - {C}_{a 3} ) + ( {A}_{a 4}^{′} - {C}_{a 4} )} ] \times Y [ μ m ]}{2 \times tan φ} \qquad [ Math . 2 ]$$

Here, the center line illustrated in FIG. 13A is the center line of the servo band.

X [μm] is a distance between the servo pattern Al and the servo pattern B1 on the center line illustrated in FIG. 13A, and Y [μm] is a distance between the servo pattern A1 and the servo pattern C1 on the center line illustrated in FIG. 13A. X and Y are obtained by developing the magnetic recording medium 10 with a ferricolloid developer and using a universal tool microscope (TOPCON TUM-220ES) and a data processer (TOPCON CA-1B). In an arbitrary site in the tape length direction, 50 servo frames are selected, X and Y are obtained in each servo frame, and simple averages of the data of 50 servo frames are regarded as X and Y used in the above calculation formula.

The difference (Bₐᵢ−Aₐᵢ) indicates the time [sec] on the actual path between the corresponding two servo patterns B1 and A1. Similarly, other difference terms also indicate the time [sec] on the actual path between the corresponding two servo patterns. These times are each determined from the time between the timing signals obtained from the waveform of the servo signal and the tape traveling speed. In the present description, the actual path means a position where the servo signal reading head actually travels on the servo signal.

φ is an azimuth angle. φ is obtained by developing the magnetic recording medium 10 with a ferricolloid developer and using a universal tool microscope (TOPCON TUM-220ES) and a data processer (TOPCON CA-1B).

In the present technology, the standard deviation σPES of the PES value is calculated using servo signals obtained by correcting the movement of the tape in the lateral direction. Furthermore, the servo signals are subjected to high pass filter processing in order to reflect the followability of the head. In the present technology, the standard deviation σPES is determined using signals obtained by the correction and the high pass filter processing of the servo signals, and is so-called a written-in PESσ.

A method of measuring the standard deviation σPES of the PES value will be described below.

First, a servo signal is read by the head 300 in an arbitrary range of 1 m in the data recording area of the magnetic recording medium 10. Subtraction between the signals acquired by the head portions 300A and 300B is performed as illustrated in FIG. 13C to obtain a servo signal in which the movement of the tape in the lateral direction is corrected. Then, the corrected servo signal is subjected to high pass filter processing. When the magnetic recording medium 10 actually travels in a drive, the recording and reproducing head mounted on the drive moves in the width direction of the magnetic recording medium 10 by an actuator so as to follow the servo signal. The written in PESσ is a noise value after considering the followability of the head in the width direction, and therefore the high pass filter processing is required. Thus, the high pass filter is not particularly limited, but needs to be a function capable of reproducing the followability of the drive head in the width direction. Using the signal obtained by the high pass filter processing, the value of the PES is calculated for each servo frame in accordance with the above calculation formula. The standard deviation of the value of the PES calculated over 1 m (written in PESσ) is the standard deviation σPES of the PES value in the present technology.

### (Squareness Ratio Rs2 in Vertical Direction)

The squareness ratio Rs2 of the magnetic recording medium of the present technology in the vertical direction (thickness direction) can be preferably 65% or more, more preferably 67% or more, and still more preferably 70% or more. If the squareness ratio Rs2 is 65% or more, the vertical orientation of the magnetic powder is sufficiently high, so that a more excellent SNR can be obtained. Therefore, a more excellent electromagnetic conversion characteristic can be obtained. Furthermore, the servo signal shape is improved, and control on the drive side is more easily performed.

In the present description, the vertical orientation of the magnetic recording medium may mean that the squareness ratio Rs2 of the magnetic recording medium is within the above numerical range (for example, 65% or more).

The squareness ratio Rs2 in the vertical direction is determined as follows. First, the magnetic tape T accommodated in the magnetic recording cartridge 10A is unwound, and the magnetic tape T is cut out in a length of 250 mm at a position 30 m from the connection portion 221 between the magnetic tape T and the leader tape LT in the longitudinal direction to prepare a sample. The sample is punched into 6.25 mm×64 mm, and then folded in three to prepare a measurement sample of 6.25 mm×8 mm. Then, the M-H hysteresis loop of the measurement sample (the entire magnetic tape T) corresponding to the vertical direction (thickness direction) of the magnetic tape T is measured using a VSM. Next, the coating film (the underlayer 12, the magnetic layer 13, the back layer 14, and the like) are wiped using acetone, ethanol, or the like, and only the base layer 11 is left. Then, the obtained base layer 11 is punched into 6.25 mm×64 mm, and then folded in three to obtain a sample of 6.25 mm×8 mm for background correction (hereinafter, simply referred to as “sample for correction”). Thereafter, the M-H hysteresis loop of the sample for correction (base layer 11) corresponding to the vertical direction of the base layer 11 (vertical direction of the magnetic recording medium 10) is measured using a VSM.

In the measurement of the M-H hysteresis loop of the measurement sample (the entire magnetic tape T) and the M-H hysteresis loop of the sample for correction (base layer 11), a high-sensitivity vibrating sample magnetometer “model VSM-P7-15” manufactured by Toei Industry Co., Ltd. is used. The measurement conditions are as follows: measurement mode: full loop, maximum magnetic field: 15 kOe, magnetic field step: 40 bits, time constant of locking amp: 0.3 sec, waiting time: 1 sec, and MH average number: 20.

After obtaining the M-H hysteresis loop of the measurement sample (the entire magnetic tape T) and the M-H hysteresis loop of the sample for correction (base layer 11), the M-H hysteresis loop of the sample for correction (base layer 11) is subtracted from the M-H hysteresis loop of the measurement sample (the entire magnetic tape T) to perform background correction, and an M-H hysteresis loop after background correction is obtained. For calculation of the background correction, a measurement/analysis program attached to “model VSM-P7-15” is used.

The saturation magnetization amount Ms (emu) and the residual magnetization Mr (emu) of the obtained M-H hysteresis loop after background correction are substituted in the following formula to calculate the squareness ratio Rs2(%). Note that every measurement of the M-H hysteresis loop described above is performed at 25° C. Furthermore, when the M-H hysteresis loop is measured in the vertical direction of the magnetic tape T, “demagnetizing field correction” is not performed. Note that for this calculation, a measurement/analysis program attached to “model VSM-P7-15” is used.

$$Squareness ratio Rs 2 ( \% ) = ( Mr / Ms ) \times 100$$

### (Coercive Force Hc)

The coercive force Hc of the magnetic recording medium 10 in the vertical direction (thickness direction) may be preferably 160 kA/m or more, more preferably 165 kA/m or more, and still more preferably 170 kA/m or more. If the coercive force Hc is such a lower limit or more, excellent thermal stability is obtained even in a case where the average magnetic cluster size is small as described above.

The coercive force Hc may be preferably 300 kA/m or less, more preferably 290 kA/m or less, still more preferably 280 kA/m or less, 275 kA/m or less, or 270 kA/m or less. If the coercive force Hc is such an upper limit or less, recording processing by the magnetic head can be sufficiently performed.

As described above, the present technology also provides a magnetic recording medium including a magnetic layer containing a magnetic powder, and the magnetic recording medium has an average magnetic cluster size, measured on the basis of an MFM image of a surface on a side of the magnetic layer, of 1850 nm² or less, and has a coercive force Hc in the vertical direction of the magnetic recording medium of 165 kA/m or more and 300 kA/m or less. The magnetic recording medium is excellent in electromagnetic conversion specification, and is also excellent from the viewpoint of recording processing by a magnetic head.

The above-described coercive force Hc is determined as follows. First, three magnetic recording media 10 are stacked with a double-sided tape, and then punched with a φ 6.39 mm punch to prepare a measurement sample. At this time, marking is performed with an arbitrary ink having no magnetism so that the longitudinal direction (traveling direction) of the magnetic recording medium 10 can be recognized. Then, the M-H loop of the measurement sample (the entire magnetic recording medium 10) corresponding to the longitudinal direction (traveling direction) of the magnetic recording medium 10 is measured using a vibrating sample magnetometer (VSM). Next, the coating film (the underlayer 12, the magnetic layer 13, the back layer 14, and the like) are wiped using acetone, ethanol, or the like, and only the base layer 11 is left. Then, the obtained three base layers 11 are stacked with a double-sided tape, and then punched with a φ 6.39 mm punch to prepare a sample for background correction (hereinafter, simply referred to as “sample for correction”). Thereafter, the M-H loop of the sample for correction (base layer 11) corresponding to the vertical direction of the base layer 11 (vertical direction of the magnetic recording medium 10) is measured using a VSM.

In the measurement of the M-H loop of the measurement sample (the entire magnetic recording medium 10) and the M-H loop of the sample for correction (base layer 11), a high-sensitivity vibrating sample magnetometer “model VSM-P7-15” manufactured by Toei Industry Co., Ltd. is used. The measurement conditions are as follows: measurement mode: full loop, maximum magnetic field: 15 kOe, magnetic field step: 40 bits, time constant of locking amp: 0.3 sec, waiting time: 1 sec, and MH average number: 20.

After obtaining the M-H loop of the measurement sample (the entire magnetic recording medium 10) and the M-H loop of the sample for correction (base layer 11), the M-H loop of the sample for correction (base layer 11) is subtracted from the M-H loop of the measurement sample (the entire magnetic recording medium 10) to perform background correction, and an M-H loop after background correction is obtained. For calculation of the background correction, a measurement/analysis program attached to “model VSM-P7-15” is used.

The coercive force Hc is determined from the obtained M-H loop after background correction. Note that for this calculation, a measurement/analysis program attached to “model VSM-P7-15” is used. Note that every measurement of the M-H loop described above is performed at 25° C. Furthermore, when the M-H loop is measured in the longitudinal direction of the magnetic recording medium 10, “demagnetizing field correction” is not performed.

### (4) Method of Manufacturing Magnetic Recording Medium

Next, a method of manufacturing the magnetic recording medium 10 having the above-described configuration will be described. First, a non-magnetic powder, a binder, and the like are kneaded and/or dispersed in a solvent to prepare a coating material for forming a non-magnetic layer (underlayer). Next, a magnetic powder, first particles, second particles, a binder, and the like are kneaded and/or dispersed in a solvent to prepare a coating material for forming a magnetic layer. For the preparation of the coating material for forming a magnetic layer and the coating material for forming a non-magnetic layer (underlayer), for example, the following solvents, dispersing apparatus, and kneading apparatus can be used.

Examples of the solvent used in the preparation of the coating material described above include ketone-based solvents such as acetone, methyl ethyl ketone, methyl isobutyl ketone, cyclohexanone, and the like, alcohol-based solvents such as methanol, ethanol, propanol, and the like, ester-based solvents such as methyl acetate, ethyl acetate, butyl acetate, propyl acetate, ethyl lactate, ethylene glycol acetate, and the like, ether-based solvents such as diethylene glycol dimethyl ether, 2-ethoxyethanol, tetrahydrofuran, dioxane, and the like, aromatic hydrocarbon-based solvents such as benzene, toluene, xylene, and the like, and halogenated hydrocarbon-based solvents such as methylene chloride, ethylene chloride, carbon tetrachloride, chloroform, chlorobenzene, and the like. One of these solvents may be used, or a mixture of two or more thereof may be used.

As the kneading apparatus used in the preparation of the coating material described above, for example, a kneading apparatus can be used such as a continuous biaxial kneader, a continuous biaxial kneader capable of diluting in multiple steps, a kneader, a press kneader, a roll kneader, or the like, but the kneading apparatus is not particularly limited thereto. Furthermore, as the dispersing apparatus used in the preparation of the coating material described above, for example, a dispersing apparatus can be used such as a bead mill, a roll mill, a ball mill, a horizontal sand mill, a vertical sand mill, a spike mill, a pin mill, a tower mill, a pearl mill (for example, “DCP Mill” manufactured by Nippon Eirich Co., Ltd., or the like), a homogenizer, an ultrasonic dispersing apparatus, or the like, but the dispersing apparatus is not particularly limited thereto.

In a preferred embodiment, the coating material for forming a magnetic layer is prepared so that a magnetic recording medium to be manufactured has the above-described characteristic relating to the average magnetic cluster size (for example, a characteristic of having an average magnetic cluster size of 1850 nm² or less) and a characteristic relating to the first particles and the second particles (for example, a characteristic of having a ratio H₁/H₂ of 2.00 or less).

For the preparation, for example, processing conditions of kneading and/or dispersing the magnetic powder, the first particles, and the second particles (for example, the type of apparatus, the time, and the like) may be adjusted. In one embodiment, a bead mill may be used as an apparatus for dispersion. The bead diameter may be appropriately selected by those skilled in the art according to the size of particles to be dispersed. Furthermore, the coating material for achieving the above characteristics can be adjusted by adjusting the dispersion time. For example, the average magnetic cluster size can be reduced by increasing the time for dispersion of the magnetic powder. The dispersion time (in particular, the actual dispersion time) may be, for example, 30 minutes to 3 hours, and preferably 30 minutes to 2 hours. The dispersion time may be appropriately adjusted by those skilled in the art, for example, according to the kind of the particles, and the like.

Furthermore, for the preparation, for example, the content of the magnetic powder, the content of the first particles, and the content of the second particles may be adjusted. For example, in the case of employing a magnetic powder having a further small average particle volume, the dispersion state of these particles can be made further appropriate by reducing the content of the first particles and/or the second particles, and thus the heights of the protrusions formed by these particles can be adjusted to an appropriate height.

The content of the first particles may be, for example, 1 part by mass to 15 parts by mass, and preferably 2 parts by mass to 10 parts by mass per 100 parts by mass of the magnetic powder. The content of the second particles may also be, for example, 1 part by mass to 15 parts by mass, and preferably 2 parts by mass to 10 parts by mass per 100 parts by mass of the magnetic powder. The content of each particle may be appropriately selected by those skilled in the art from such a numerical range.

In a particularly preferred embodiment, the dispersion of the magnetic powder in the solvent and the dispersion of the first particles and the second particles in the solvent are separately performed. If dispersion of the magnetic powder and dispersion of the inorganic material are separately performed as described above, the dispersion state of these materials can be appropriately adjusted, and the above-described characteristics can be easily achieved. In this embodiment, a bead mill may be used as an apparatus for dispersion. The bead diameter may be appropriately selected by those skilled in the art according to the size of particles to be dispersed. The dispersion time (in particular, the actual dispersion time) may be, for example, 30 minutes to 3 hours, and preferably 30 minutes to 2 hours. The dispersion time may be appropriately adjusted by those skilled in the art, for example, according to the kind of the particles, and the like. Then, the characteristics are achieved, and thus the electromagnetic conversion characteristic and/or the traveling performance of the magnetic recording medium can be improved. For adjusting the dispersion state, for example, the dispersion time and/or the amount of each component to be blended may be adjusted.

That is, the method of manufacturing includes a step of preparing a coating material for forming a magnetic layer, and the step may include a first dispersion step of dispersing the magnetic powder in a solvent and a second dispersion step of dispersing the first particles and the second particles in a solvent.

In the first dispersion step, a first composition is obtained in which the magnetic powder is dispersed in a solvent (in particular, a binder-containing solvent, such as a resin-containing solvent).

In the second dispersion step, a second composition is obtained in which the first particles and the second particles are dispersed in a solvent (in particular, a binder-containing solvent, such as a resin-containing solvent).

The step of preparing a coating material for forming a magnetic layer includes a mixing step of mixing the first composition and the second composition. In the mixing step, another composition (in particular, a binder-containing solvent, such as a resin-containing solvent) may be further mixed. In the mixing step, a coating material for forming a magnetic layer is manufactured.

Note that in another embodiment, the step of preparing a coating material for forming a magnetic layer may include a first dispersion step of dispersing the magnetic powder in a solvent, a second dispersion step of dispersing the first particles in a solvent, and a third dispersion step of dispersing the second particles in a solvent. As described above, dispersion of the magnetic powder, dispersion of the first particles, and dispersion of the second particles may be separately performed. Also in this embodiment, the dispersion state of these materials can be appropriately adjusted, and the above-described characteristics can be easily achieved. Then, the characteristics are achieved, and thus the electromagnetic conversion characteristic and/or the traveling performance of the magnetic recording medium can be improved. Also in this embodiment, for adjusting the dispersion state, for example, the dispersion time and/or the amount of each component to be blended may be adjusted.

Next, the coating material for forming a non-magnetic layer (underlayer) is applied to one principal plane of a base layer 11 and dried to form a non-magnetic layer 12. Subsequently, the coating material for forming a magnetic layer is applied onto the non-magnetic layer 12 and dried to form a magnetic layer 13 on the non-magnetic layer 12. Note that, at the time of drying, the magnetic powder is magnetically oriented in the thickness direction of the base layer 11 with, for example, a solenoid coil. Furthermore, at the time of drying, for example, the magnetic powder may be magnetically oriented in the longitudinal direction (traveling direction) of the base layer 11 and then magnetically oriented in the thickness direction of the base layer 11 with a solenoid coil. By performing such magnetic orientation processing, the ratio Hc2/Hc1 of the holding force “Hc2” in the longitudinal direction to the holding force “Hc1” in the vertical direction can be reduced, and the degree of vertical orientation of the magnetic powder can be improved. After forming the magnetic layer 13, a back layer 14 is formed on the other principal plane of the base layer 11. Thus, a magnetic recording medium 10 is obtained.

The ratio Hc2/Hc1 is, for example, set to a desired value by adjusting the strength of the magnetic field applied to the coating film of the coating material for forming a magnetic layer, the concentration of the solid content in the coating material for forming a magnetic layer, and drying conditions of the coating film of the coating material for forming a magnetic layer (the drying temperature and the drying time). The strength of the magnetic field applied to the coating film is preferably 2 times or more and 3 times or less the holding force of the magnetic powder. In order to further increase the ratio Hc2/Hc1, it is also preferable to magnetize the magnetic powder at a stage before the coating material for forming a magnetic layer is put in an orienting apparatus for magnetically orienting the magnetic powder. Note that methods of adjusting the ratio Hc2/Hc1 may be used alone or in combination of two or more thereof.

Thereafter, the obtained magnetic recording medium 10 is rewound around a large-diameter core, and curing processing is performed. Finally, the magnetic recording medium 10 is calendered and then cut into a predetermined width (for example, a width of ½ inches). Thus, a target elongated magnetic recording medium 10 is obtained.

### (5) Recording and Reproducing Apparatus

### [Configuration of Recording and Reproducing Apparatus]

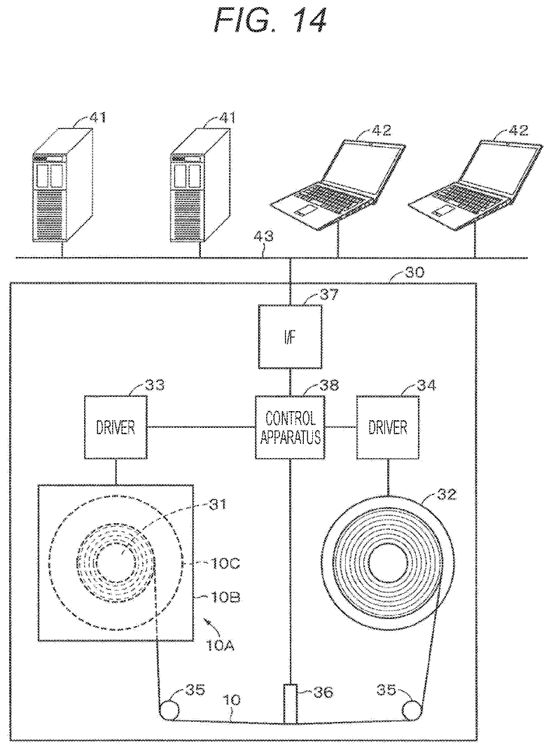

Next, an example of a configuration of a recording and reproducing apparatus 30 that performs recording and reproducing of the magnetic recording medium 10 having the above-described configuration will be described with reference to FIG. 14.

The recording and reproducing apparatus 30 may be configured to be capable of adjusting the tension applied to the magnetic recording medium 10 in the longitudinal direction. Furthermore, the recording and reproducing apparatus 30 has a configuration in which a magnetic recording cartridge 10A can be loaded. Here, in order to make the description easy, a case is described in which the recording and reproducing apparatus 30 has a configuration in which one magnetic recording cartridge 10A can be loaded, but the recording and reproducing apparatus 30 may have a configuration in which a plurality of magnetic recording cartridges 10A can be loaded.

The recording and reproducing apparatus 30 is preferably a timing servo type magnetic recording and reproducing apparatus. The magnetic recording medium of the present technology is suitable for use in a timing servo type magnetic recording and reproducing apparatus.

The recording and reproducing apparatus 30 is connected to information processors such as a server 41, a personal computer (hereinafter referred to as “PC”) 42, and the like via a network 43, and is configured to be capable of recording data supplied from the information processors in the magnetic recording cartridge 10A. The shortest recording wavelength of the recording and reproducing apparatus 30 is preferably 100 nm or less, more preferably 75 nm or less, still more preferably 60 nm or less, and particularly preferably 50 nm or less.

As illustrated in FIG. 14, the recording and reproducing apparatus includes a spindle 31, a reel 32 on the recording and reproducing apparatus side, a spindle driver 33, a reel driver 34, a plurality of guide rollers 35, a head unit 36, a communication interface (hereinafter, I/F) 37, and a control apparatus 38.

The spindle 31 is configured so that the magnetic recording cartridge 10A can be loaded thereon. The magnetic recording cartridge 10A conforms to the Linear Tape-Open (LTO) standard and includes a cartridge case 10B accommodating a rotatable single reel 10C in which the magnetic recording medium 10 is wound. In the magnetic recording medium 10, a servo pattern in an inverted V-shape is recorded in advance as a servo signal. The reel 32 is configured to be capable of fixing a leading end of the magnetic recording medium 10 drawn out from the magnetic recording cartridge 10A.

The present technology also provides a magnetic recording cartridge including the magnetic recording medium according to the present technology. In the magnetic recording cartridge, for example, the magnetic recording medium may be wound around a reel, and may be accommodated in a case in a state of being wound around the reel.

The spindle driver 33 is an apparatus that rotationally drives the spindle 31. The reel driver 34 is an apparatus that rotationally drives the reel 32. When the data is recorded in or reproduced from the magnetic recording medium 10, the spindle driver 33 and the reel driver 34 rotationally drive the spindle 31 and the reel 32, respectively, to allow the magnetic recording medium 10 to travel. The guide rollers 35 are a roller for guiding travel of the magnetic recording medium 10.

The head unit 36 includes a plurality of recording heads for recording data signals in the magnetic recording medium 10, a plurality of reproducing heads for reproducing the data signals recorded in the magnetic recording medium 10, and a plurality of servo heads for reproducing the servo signals recorded in the magnetic recording medium 10. As the recording head, for example, a ring head can be used, but the type of the recording head is not limited thereto.

The communication I/F 37 is for communicating with the information processors such as the server 41, the PC 42, and the like, and is connected to the network 43.

The control apparatus 38 controls a whole of the recording and reproducing apparatus 30. For example, in response to a request from the information processors such as the server 41, the PC 42, and the like, the control apparatus 38 records the data signal supplied from the information processor in the magnetic recording medium 10 by the head unit 36. Furthermore, in response to a request from the information processors such as the server 41, the PC 42, and the like, the control apparatus 38 reproduces the data signal recorded in the magnetic recording medium 10 by the head unit 36 and supplies the data signal to the information processor.

Furthermore, the control apparatus 38 detects a change in the width of the magnetic recording medium 10 on the basis of a servo signal supplied from the head unit 36. Specifically, a plurality of servo patterns in an inverted V-shape is recorded as servo signals in the magnetic recording medium 10, and the head unit 36 can simultaneously reproduce two different servo patterns by two servo heads on the head unit 36 to obtain respective servo signals. Using the relative position information between the servo pattern and the head unit obtained from the servo signal, the position of the head unit 36 is controlled so as to follow the servo pattern. At the same time, two servo signal waveforms are compared, and thus the distance information between the servo patterns can also be obtained. The distance information between servo patterns obtained at the time of each measurement are compared, and thus a change in the distance between servo patterns at the time of each measurement can be obtained. To the obtained change, the distance information between servo patterns at the time of recording the servo patterns is added, and thus a change in the width of the magnetic recording medium 10 can also be calculated. The control apparatus 38 controls rotational driving of the spindle driver 33 and the reel driver 34 on the basis of the change in the distance between servo patterns obtained as described above or the calculated change in the width of the magnetic recording medium 10, and adjusts the tension of the magnetic recording medium 10 in the longitudinal direction so that the magnetic recording medium 10 has a prescribed width or a substantially prescribed width. Thus, a change in the width of the magnetic recording medium 10 can be suppressed.

### [Operation of Recording and Reproducing Apparatus]

Next, an operation of the recording and reproducing apparatus 30 having the above configuration will be described.

First, the magnetic recording cartridge 10A is loaded in the recording and reproducing apparatus 30, a leading end of the magnetic recording medium 10 is drawn out and transferred to the reel 32 via the plurality of guide rollers 35 and the head unit 36, and the leading end of the magnetic recording medium 10 is attached to the reel 32.

Next, when an operation unit (not illustrated) is operated, the spindle driver 33 and the reel driver 34 are driven by control of the control apparatus 38, and the spindle 31 and the reel 32 are rotated in the same direction so that the magnetic recording medium 10 travels from the reel 10C toward the reel 32. As a result, while the magnetic recording medium 10 is wound around the reel 32, the head unit 36 records information in the magnetic recording medium 10 or reproduces the information recorded in the magnetic recording medium 10.

Furthermore, when the magnetic recording medium 10 is rewound around the reel 10C, the spindle 31 and the reel 32 are rotationally driven in the direction opposite to the above direction, and thus the magnetic recording medium 10 travels from the reel 32 to the reel 10C. Also at the time of rewinding, the head unit 36 records information in the magnetic recording medium 10 or reproduces the information recorded in the magnetic recording medium 10.

### (6) Modified Examples

### Modified Example 1

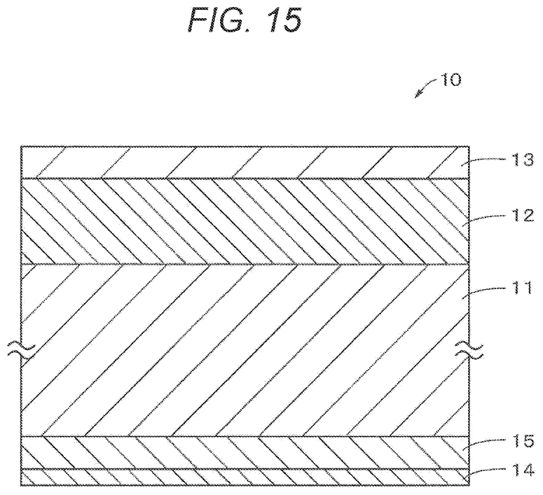

The magnetic recording medium 10 may further include a barrier layer 15 provided on at least one surface of the base layer 11 as illustrated in FIG. 15. The barrier layer 15 is a layer for suppressing dimensional deformation of the base layer 11 according to the environment. For example, the hygroscopicity of the base layer 11 is one of examples of the cause of the dimensional deformation, and the barrier layer 15 can reduce the penetration speed of moisture into the base layer 11. The barrier layer 15 contains a metal or a metal oxide. As the metal, for example, at least one of Al, Cu, Co, Mg, Si, Ti, V, Cr, Mn, Fe, Ni, Zn, Ga, Ge, Y, Zr, Mo, Ru, Pd, Ag, Ba, Pt, Au, or Ta can be used. As the metal oxide, for example, at least one of Al₂O₃, CuO, CoO, SiO₂, CrO₂O₃, TiO₂, Ta₂O₅, or ZrO₂ can be used, and any of oxides of the above-described metals can also be used. Furthermore, diamond-like carbon (DLC), diamond, or the like can be used.

The average thickness of the barrier layer 15 is preferably 20 nm or more and 1000 nm or less, and more preferably 50 nm or more and 1000 nm or less. The average thickness of the barrier layer 15 is determined in a manner similar to that for determination of the average thickness tₘ, of the magnetic layer 13. However, the magnification of the TEM image is appropriately adjusted according to the thickness of the barrier layer 15.

### Modified Example 2

The magnetic recording medium 10 may be incorporated in a library apparatus. That is, the present technology also provides a library apparatus including at least one magnetic recording medium 10. The library apparatus has a configuration capable of adjusting the tension applied to the magnetic recording medium 10 in the longitudinal direction, and may include a plurality of the above-described recording and reproducing apparatus 30.

### Modified Example 3

The magnetic recording medium 10 may be subjected to servo signal write processing by a servo writer. The servo writer adjusts the tension of the magnetic recording medium 10 in the longitudinal direction at the time of, for example, recording a servo signal, and thus the width of the magnetic recording medium 10 can be kept constant or substantially constant. In this case, the servo writer can include a detector that detects the width of the magnetic recording medium 10. The servo writer can adjust the tension of the magnetic recording medium 10 in the longitudinal direction on the basis of the detection result by the detector.

### 3. SECOND EMBODIMENT

### (1) Embodiment of Magnetic Recording Cartridge

### [Configuration of Cartridge]

The present technology also provides a magnetic recording cartridge (also referred to as a tape cartridge) including the magnetic recording medium according to the present technology. In the magnetic recording cartridge, the magnetic recording medium may be wound around, for example, a reel. The magnetic recording cartridge may include, for example, a communication unit that communicates with a recording and reproducing apparatus, a storage unit, and a control unit that stores information received from the recording and reproducing apparatus via the communication unit in the storage unit, reads the information from the storage unit in response to a request from the recording and reproducing apparatus, and transmits the information to the recording and reproducing apparatus via the communication unit. The information may include adjustment information for adjusting the tension applied to the magnetic recording medium in the longitudinal direction.

An example of a configuration of a magnetic recording cartridge 10A including the magnetic recording medium T having the above-described configuration will be described with reference to FIG. 16.

FIG. 16 is an exploded perspective view illustrating an example of a configuration of a magnetic recording cartridge 10A. The magnetic recording cartridge 10A is a magnetic recording cartridge conforming to the Linear Tape-Open (LTO) standard, and includes, inside a cartridge case 10B including a lower shell 212A and an upper shell 212B, a reel 10C in which a magnetic tape (tape-shaped magnetic recording medium) T is wound, a reel lock 214 and a reel spring 215 for locking rotation of the reel 10C, a spider 216 for unlocking the locking state of the reel 10C, a slide door 217 for opening and closing a tape outlet 212C provided in the cartridge case 10B across the lower shell 212A and the upper shell 212B, a door spring 218 for energizing the slide door 217 to the closed position of the tape outlet 212C, a write protect 219 for preventing erroneous erasure, and a cartridge memory 211. The reel 10C has a substantially disk shape having an opening at the center portion, and includes a reel hub 213A and a flange 213B made of a hard material such as plastic and the like. A leader tape LT is connected to one end portion of the magnetic tape T. A leader pin 220 is provided at a leading end of the leader tape LT.

The cartridge memory 211 is provided in the vicinity of one corner of the magnetic recording cartridge 10A. In a state where the magnetic recording cartridge 10A is loaded in a recording and reproducing apparatus 80, the cartridge memory 211 faces a reader/writer (not illustrated) of the recording and reproducing apparatus 80. The cartridge memory 211 communicates with a recording and reproducing apparatus 30, specifically, a reader/writer (not illustrated) in accordance with a wireless communication standard based on the LTO standard.

### [Configuration of Cartridge Memory]

An example of a configuration of the cartridge memory 211 will be described with reference to FIG. 17.

FIG. 17 is a block diagram illustrating an example of a configuration of the cartridge memory 211. The cartridge memory 211 includes an antenna coil (communication unit) 331 that communicates with a reader/writer (not illustrated) in accordance with a prescribed communication standard, a rectification/power supply circuit 332 that generates and rectifies a power to generate a power supply using an induced electromotive force from a radio wave received by the antenna coil 331, a clock circuit 333 that generates a clock similarly using the induced electromotive force from the radio wave received by the antenna coil 331, a detection/modulation circuit 334 that detects the radio wave received by the antenna coil 331 and modulates a signal to be transmitted by the antenna coil 331, a controller (control unit) 335 including a logic circuit and the like for discriminating commands and data from digital signals extracted from the detection/modulation circuit 334 and processing the commands and the data, and a memory (storage unit) 336 that stores information. Furthermore, the cartridge memory 211 includes a capacitor 337 connected in parallel to the antenna coil 331 to configure a resonance circuit with the antenna coil 331 and the capacitor 337.

The memory 336 stores information and the like relating to the magnetic recording cartridge 10A. The memory 336 is a non volatile memory (NVM) The memory 336 preferably has a storage capacity of about 32 KB or more. For example, in a case where the magnetic recording cartridge 10A conforms to the next generation or later LTO format standard, the memory 336 has a storage capacity of about 32 KB.

The memory 336 includes a first storage area 336A and a second storage area 336B. The first storage area 336A corresponds to a storage area of a cartridge memory of an LTO standard prior to LTO 8 (hereinafter, referred to as a “conventional cartridge memory”), and is an area for storing information conforming to the LTO standard prior to LTO8. The information conforming to the LTO standard prior to LTO8 is, for example, manufacturing information (for example, a unique number of the magnetic recording cartridge 10A, or the like), a use history (for example, the number of times of tape withdrawal (thread count), or the like), and the like.

The second storage area 336B corresponds to an extended storage area with respect to a storage area of a conventional cartridge memory. The second storage area 336B is an area for storing additional information. Here, the additional information means information, relating to the magnetic recording cartridge 10A, that is not prescribed in the LTO standard prior to LTO8. Examples of the additional information include, but are not limited to, data such as tension adjustment information, management ledger data, index information, thumbnail information of a moving image stored in the magnetic tape T, and the like. The tension adjustment information includes the distance between adjacent servo bands (the distance between servo patterns recorded in adjacent servo bands) at the time of recording data in the magnetic tape T. The distance between adjacent servo bands is an example of width-related information relating to the width of the magnetic tape T. Details of the distance between servo bands will be described below. In the following description, the information stored in the first storage area 336A may be referred to as “first information”, and the information stored in the second storage area 336B may be referred to as “second information”.

The memory 336 may have a plurality of banks. In this case, some of the plurality of banks may constitute the first storage area 336A, and the remaining banks may constitute the second storage area 336B. Specifically, for example, in a case where the magnetic recording cartridge 10A conforms to the next generation or later LTO format standard, the memory 336 may include two banks having a storage capacity of about 16 KB, one of the two banks may constitute the first storage area 336A, and the other bank may constitute the second storage area 336B.

The antenna coil 331 induces an induced voltage by electromagnetic induction. The controller 335 communicates with the recording and reproducing apparatus 80 in accordance with a prescribed communication standard via the antenna coil 331. Specifically, for example, mutual authentication, command transmission/reception, data exchange, and the like are performed.

The controller 335 stores the information received from the recording and reproducing apparatus 80 via the antenna coil 331 in the memory 336. In response to a request from the recording and reproducing apparatus 80, the controller 335 reads information from the memory 336 and transmits the information to the recording and reproducing apparatus 80 via the antenna coil 331.

### (2) Modified Example of Magnetic Recording Cartridge

### [Configuration of Cartridge]

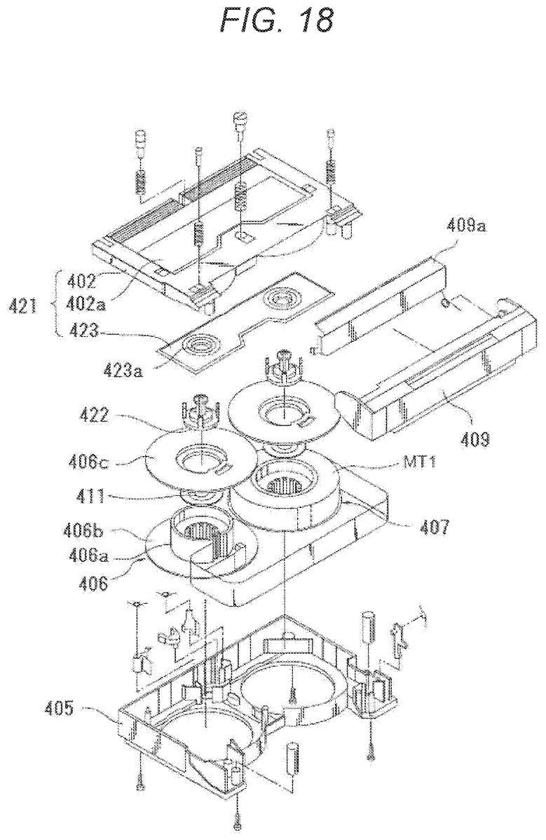

In one embodiment of the magnetic recording cartridge described above, a case where the magnetic tape cartridge is a one-reel cartridge is described, but the magnetic recording cartridge of the present technology may be a two-reel cartridge. That is, the magnetic recording cartridge of the present technology may have one or a plurality of (for example, two) reels around which the magnetic tape is wound. Hereinafter, an example of the magnetic recording cartridge of the present technology having two reels will be described with reference to FIG. 18.

FIG. 18 is an exploded perspective view illustrating an example of a configuration of a two-reel cartridge 421. The cartridge 421 includes an upper half 402 including a synthetic resin, a transparent window member 423 fitted and fixed to a window portion 402a opened in an upper surface of the upper half 402, reel holders 422 fixed to an inner side of the upper half 402 and preventing uplift of reels 406 and 407, a lower half 405 corresponding to the upper half 402, the reels 406 and 407 stored in a space formed by combining the upper half 402 and the lower half 405, a magnetic tape MT1 wound around the reels 406 and 407, a front lid 409 closing a front side opening formed by combining the upper half 402 and the lower half 405, and a back lid 409A protecting the magnetic tape MT1 exposed at the front side opening.

The reel 406 includes a lower flange 406b having a cylindrical hub portion 406a, in a central portion, around which the magnetic tape MT1 is wound, an upper flange 406c having substantially the same size as the lower flange 406b, and a reel plate 411 interposed between the hub portion 406a and the upper flange 406c. The reel 407 has a configuration similar to that of the reel 406.

The window member 423 is provided with attachment holes 423a at positions corresponding to the reels 406 and 407, respectively, for assembling the reel holders 422 as reel holding units that prevent the reels from being lifted up. The magnetic tape MT1 is similar to the magnetic tape T in the first embodiment.

The present technology can also employ the following configurations.

[1]

A magnetic recording medium including a magnetic layer containing a magnetic powder,
the magnetic recording medium having an average magnetic cluster size of 1850 nm² or less, the average magnetic cluster size measured on the basis of an MFM image of a surface on a side of the magnetic layer,
the magnetic layer containing first particles having conductivity and second particles having a Mohs hardness of 7 or more, in which
protrusions are formed by the first particles and protrusions are formed by the second particles on the surface on the side of the magnetic layer, and
a ratio (H₁/H₂) of an average height H₁ of the protrusions formed by the first particles to an average height H₂ of the protrusions formed by the second particles is 2.00 or less.

[2]

The magnetic recording medium according to [1], in which the average height H: is 13.0 nm or less. [3]

The magnetic recording medium according to [1], in which the average height H₁ is 12.0 nm or less. [4]

The magnetic recording medium according to [1], in which the average height H₁ is 11.0 nm or less.

[5]

The magnetic recording medium according to any one of [1] to [4], in which the average height H₂ is 7.5 nm or less. [6]

The magnetic recording medium according to any one of [1] to [4], in which the average height H₂ is 7.0 nm or less. [7]

The magnetic recording medium according to any one of [1] to [4], in which the average height H₂ is 6.5 nm or less. [8]

The magnetic recording medium according to any one of [1] to [7], in which the average magnetic cluster size is 1800 nm² or less. [9]

The magnetic recording medium according to any one of [1] to [7], in which the average magnetic cluster size is 1700 nm² or less. [10]

The magnetic recording medium according to any one of [1] to [7], in which the average magnetic cluster size is 1600 nm² or less. [11]

The magnetic recording medium according to any one of [1] to [10], having an average thickness t_{T} of 5.1 μm or less. [12]

The magnetic recording medium according to any one of [1] to [11], having a coercive force Hc in a vertical direction of the magnetic recording medium of 165 kA/m or more and 300 kA/m or less.

[13]

The magnetic recording medium according to any one of [1] to [12], in which the first particles include carbon particles. [14]

The magnetic recording medium according to any one of [1] to [13], in which the second particles include inorganic particles. [15]

The magnetic recording medium according to any one of [1] to [14], in which a number of the protrusions formed by the first particles on the surface on the side of the magnetic layer is 2.5 or less per unit area (μm²). [16]

The magnetic recording medium according to any one of [1] to [15], in which a number of the protrusions formed by the second particles on the surface on the side of the magnetic layer is 2.0 or more per unit area (μm²). [17]

The magnetic recording medium according to any one of [1] to [16], in which the magnetic layer has an average thickness of 0.08 μm or less. [18]

A magnetic recording medium including a magnetic layer containing a magnetic powder,
the magnetic recording medium having an average magnetic cluster size of 1850 nm² or less, the average magnetic cluster size measured on the basis of an MFM image of a surface on a side of the magnetic layer,
the magnetic recording medium having a coercive force Hc in a vertical direction of the magnetic recording medium of 165 kA/m or more and 300 kA/m or less. [19]

A magnetic recording cartridge including the magnetic recording medium according to any one of [1] to [18] in a state of being wound around a reel, the magnetic recording medium accommodated in a case.

### 4. EXAMPLES

Hereinafter, the present technology will be described more specifically with reference to Examples, but the present technology is not limited only to these Examples. Note that values of various parameters appearing in these Examples are obtained by the above-described measurement methods unless otherwise specified.

### 4-1. Evaluation of Influence of Average Magnetic Cluster Size on Electromagnetic Conversion Characteristic

### Example 1

### (Step of Preparing Coating Material for Forming Magnetic Layer)

A coating material for forming a magnetic layer was prepared as follows. First, a first composition having the following formulation was obtained by kneading with an extruder. Furthermore, a second composition having the following formulation was obtained by stirring with a disperser. That is, the dispersion of the magnetic powder and the dispersion of the first particles and the second particles were separately performed. Next, the obtained first composition and second composition and a third composition having the following formulation were added to a stirring tank equipped with a disperser, and premixing was performed. Subsequently, sand mill mixing was further performed, and filter treatment was performed to prepare a coating material for forming a magnetic layer.

### (First Composition)

Magnetic powder (hexagonal ferrite having M-type structure, composition: Ba-ferrite, shape: plate-shaped hexagonal particles, average particle volume: 1680 nm³): 100 parts by mass
Vinyl chloride-based resin (cyclohexanone solution 30 mass %): 45 parts by mass
(degree of polymerization: 300, Mn=10000, OSO₃K=0.07 mmol/g and secondary OH=0.3 mmol/g are contained as polar groups).

### (Second Composition)

Aluminum oxide powder: 7.5 parts by mass
(α-Al₂O₃, average particle diameter: 80 nm, manufactured by SUMITOMO CHEMICAL COMPANY, LIMITED, trade name: HIT82, Mohs hardness: 9)
Carbon black: 2.0 parts by mass
(average particle diameter: 70 nm, manufactured by TOKAI CARBON CO., LTD., trade name: SEAST TA)
Vinyl chloride-based resin described above (cyclohexanone solution 30 mass %): 8.8 parts by mass

### (Third Composition)

Vinyl chloride-based resin: 1.6 parts by mass (as cyclohexanone solution 30 mass % resin)
n-Butyl stearate: 2 parts by mass
Methyl ethyl ketone: 121.3 parts by mass
Toluene: 121.3 parts by mass
Cyclohexanone: 60.7 parts by mass

Finally, 2 parts by mass of polyisocyanate (trade name: Coronate L, manufactured by Nippon Polyurethane Industry Co., Ltd.) as a curing agent and 2 parts by mass of myristic acid were added to the coating material for forming a magnetic layer prepared as described above.

(Step of Preparing Coating Material for Forming Underlayer)

A coating material for forming an underlayer was prepared as follows. First, a fourth composition having the following formulation was kneaded with an extruder. Next, the kneaded fourth composition and a fifth composition having the following formulation were added to a stirring tank equipped with a disperser, and premixing was performed. Subsequently, sand mill mixing was further performed, and filter treatment was performed to prepare a coating material for forming an underlayer.

### (Fourth Composition)

Acicular iron oxide powder: 100 parts by mass
(α-Fe₂O₃, average long axis length: 0.15 μm)
Aluminum oxide powder: 5 parts by mass
(α-Al₂O₃, average particle diameter: 80 nm, manufactured by SUMITOMO CHEMICAL COMPANY, LIMITED, trade name: HIT82, Mohs hardness: 9)
Vinyl chloride-based resin: 55.6 parts by mass
(resin solution: resin content 30 mass %, cyclohexanone 70 mass %)
Carbon black: 10 parts by mass
(average particle diameter: 20 nm)

### (Fifth Composition)

Polyurethane-based resin UR8200 (manufactured by TOYOBO CO., LTD.): 18.5 parts by mass
n-Butyl stearate: 2 parts by mass
Methyl ethyl ketone: 108.2 parts by mass
Toluene: 108.2 parts by mass
Cyclohexanone: 18.5 parts by mass

Finally, 2 parts by mass of polyisocyanate (trade name: Coronate L, manufactured by Tosoh Corporation) as a curing agent and 2 parts by mass of myristic acid were added to the coating material for forming an underlayer prepared as described above.

### (Step of Preparing Coating Material for Forming Back Layer)

A coating material for forming a back layer was prepared as follows. The following raw materials were mixed in a stirring tank equipped with a disperser and subjected to filter treatment to prepare a coating material for forming a back layer. Carbon black (manufactured by Asahi Carbon Co., Ltd., trade name: #80): 100 parts by mass
Polyester polyurethane: 100 parts by mass
(manufactured by Nippon Polyurethane Industry Co., Ltd., trade name: N-2304)
Methyl ethyl ketone: 500 parts by mass
Toluene: 400 parts by mass
Cyclohexanone: 100 parts by mass
Polyisocyanate (trade name: Coronate L, manufactured by Tosoh Corporation): 10 parts by mass

### (Film Forming Step)

A magnetic tape was prepared as described below using the coating materials prepared as described above.

First, as a support to be a base layer of a magnetic tape, a PEN film (base film) having an elongated shape and an average thickness of 4.00 μm was prepared. Next, the coating material for forming an underlayer was applied onto one principal plane of the PEN film and dried to form an underlayer on the one principal plane of the PEN film so that the underlayer in a final product had an average thickness of 1.00 μm. Next, the coating material for forming a magnetic layer was applied onto the underlayer and dried to form a magnetic layer on the underlayer so that the magnetic layer in a final product had an average thickness of 80 nm. Furthermore, the magnetic layer was subjected to vertical orientation processing using a solenoid coil.

Subsequently, the coating material for forming a back layer was applied onto the other principal plane of the PEN film on which the underlayer and the magnetic layer were formed and dried, and thus a back layer was formed so that the back layer in a final product had an average thickness of 0.50 μm. Then, the PEN film on which the underlayer, the magnetic layer, and the back layer were formed was subjected to curing processing. Thereafter, calendar processing was performed to smooth the surface of the magnetic layer.

### (Cutting Step)

The magnetic tape obtained as described above was cut into a width of ½ inches (12.65 mm). Thus, a magnetic tape having an elongated shape was obtained.

The magnetic tape having a width of ½ inches was wound around a reel provided in a cartridge case to obtain a magnetic recording cartridge. A servo signal was recorded in the magnetic tape with a servo track writer. The servo signal included a row of magnetic patterns in an inverted V-shape, and the magnetic patterns were recorded in advance in two or more rows in parallel in the longitudinal direction at a known interval (hereinafter, referred to as a “known interval between magnetic pattern rows recorded in advance”).

The obtained magnetic tape had an average magnetic cluster size of 1690 nm^{z} as shown in Table 1 below.

### Example 2

A magnetic tape was obtained in a manner similar to that in Example 1 except that the thickness of the magnetic layer, the thickness of the underlayer, and the thickness of the back layer were changed to 75 nm, 0.70 μm, and 0.40 μm, respectively, and vertical orientation processing was not performed. Then, using the magnetic tape, a magnetic recording cartridge was obtained in a manner similar to that in Example 1. The obtained magnetic tape had an average magnetic cluster size of 1702 nm² as shown in Table 1 below.

### Comparative Example 1

A magnetic tape was obtained by the same method as in Example 1 except that the configuration was changed as shown in Table 1 so that, for example, a magnetic powder was used that had a smaller average particle volume than the magnetic powder used in Example 1, and that in preparation of the coating material for forming a magnetic layer, one composition containing the magnetic powder, the aluminum oxide powder, and carbon black was subjected to dispersion without separating the first composition and the second composition. Then, using the magnetic tape, a magnetic recording cartridge was obtained in a manner similar to that in Example 1.

The obtained magnetic tape had an average magnetic cluster size of 1880 nm².

Although the magnetic powder used in Comparative Example 1 had a smaller average particle volume than the magnetic powder used in Example 1, the magnetic tape of Comparative Example 1 had a larger average magnetic cluster size than the magnetic tape of Example 1. One reason for this is considered to be that the degree of dispersion of the magnetic powder was reduced because, in preparation of the coating material for forming a magnetic layer, one composition was subjected to dispersion without separating the first composition and the second composition.

### Comparative Example 2

A magnetic tape was obtained by the same method as in Example 1 except that the configuration was changed as shown in Table 1 so that, for example, a magnetic powder was used that had a slightly larger average particle volume (1700 nm³) than the magnetic powder used in Example 1, and that in preparation of the coating material for forming a magnetic layer, the time for dispersion of the first composition and the second composition was shortened. Then, using the magnetic tape, a magnetic recording cartridge was obtained in a manner similar to that in Example 1.

The obtained magnetic tape had an average magnetic cluster size of 1944 nm².

The magnetic tape of Comparative Example 2 had a larger average magnetic cluster size than the magnetic tape of Example 1. One reason for this is considered to be that in preparation of the coating material for forming a magnetic layer, the time for dispersion of the first composition and the second composition was shortened.

### Comparative Example 31

A magnetic tape was obtained by the same method as in Example 1 except that the configuration was changed as shown in Table 1 so that, for example, a magnetic powder was used that had a smaller average particle volume (965 nm³) than the magnetic powder used in Example 1. Then, using the magnetic tape, a magnetic recording cartridge was obtained in a manner similar to that in Example 1.

The obtained magnetic tape had an average magnetic cluster size of 2210 nm².

The magnetic tape of Comparative Example 3 had a larger average magnetic cluster size than the magnetic tape of Example 1. One reason for this is considered to be that the magnetic powder had too small an average particle volume to be well dispersed in preparation of the coating material for forming a magnetic layer.

### Comparative Example 4

A magnetic tape was obtained in a manner similar to that in Example 1 except that the thickness of the magnetic layer, the thickness of the underlayer, and the thickness of the back layer were changed to 85 nm, 1.10 μm, and 0.45 μm, respectively, and vertical orientation processing was not performed. Then, using the magnetic tape, a magnetic recording cartridge was obtained in a manner similar to that in Example 1.

The obtained magnetic tape had an average magnetic cluster size of 1882 nm².

The magnetic tape of Comparative Example 4 had a larger average magnetic cluster size than the magnetic tapes of Examples 1 and 2. One reason for this is considered to be a change in the layer configuration (for example, an increase in the thickness of the magnetic layer).

### [Evaluation of Electromagnetic Conversion Characteristic]

Using the magnetic recording cartridges manufactured in Examples 1 and 2 and Comparative Examples 1 to 4, the electromagnetic conversion characteristic of the magnetic tape accommodated in each cartridge was evaluated. The evaluation was performed as follows.

First, a reproduction signal of the magnetic tape was acquired using a loop tester (manufactured by MicroPhysics Inc.). The acquisition conditions of the reproduction signal will be described below.
Head: GMR
Head speed: 1.85 m/s
Signal: single recording frequency 10 MHz (as a 2T half-Nyquist frequency)
Recording current: Optimum recording current

Next, the reproduction signal was captured at a span (SPAN) of 0 to 20 MHz (resolution band width=100 kHz, VBW=30 kHz) with a spectrum analyzer. Next, the peak of the captured spectrum was regarded as the signal amount S, and the floor noise obtained by excluding the peak was integrated from 3 MHz to 20 MHz to obtain a noise amount N. The ratio S/N of the signal amount S to the noise amount N was determined as a signal-to-noise ratio (SNR). Next, the obtained SNR was converted into a relative value (dB) based on the SNR in Example 1 as a reference medium. Table 1 also shows the evaluation result of the electromagnetic conversion characteristic of each magnetic tape.

TABLE 1
Configuration of Tape and Evaluation result of electromagnetic conversion characteristic

| | | Average | Layer configuration of tape | | | | | | | |
|---|---|---|---|---|---|---|---|---|---|---|
| | Average | particle | Magnetic | Under- | Base | Back | | | | Electromagnetic |
| | magnetic | volume of | layer | layer | layer | layer | Total | | Vertical | conversion |
| | cluster | magnetic | thick- | thick- | thick- | thick- | thick- | | direction | characteristic |
| | size | powder | ness | ness | ness | ness | ness | Vertical | Hc | SNR |
| | (nm²) | (nm³) | (nm) | (μm) | (μm) | (μm) | (μm) | orientation | (kA/m) | (dB) |
| Example 1 | 1690 | 1680 | 80 | 1.00 | 4.00 | 0.50 | 5.58 | Present | 216 | 1 |
| Example 2 | 1702 | 1690 | 75 | 0.70 | 4.00 | 0.40 | 5.18 | Absent | 202 | 1.1 |
| Comparative | 1880 | 1453 | 80 | 1.00 | 4.00 | 0.40 | 5.48 | Absent | 198 | 0.8 |
| Example 1 | | | | | | | | | | |
| Comparative | 1944 | 1700 | 65 | 0.70 | 4.40 | 0.40 | 5.57 | Present | 215 | 0.8 |
| Example 2 | | | | | | | | | | |
| Comparative | 2210 | 965 | 80 | 1.00 | 4.00 | 0.40 | 5.48 | Absent | 121 | 0.4 |
| Example 3 | | | | | | | | | | |
| Comparative | 1882 | 1690 | 85 | 1.10 | 4.00 | 0.45 | 5.64 | Absent | 226 | 0.5 |
| Example 4 | | | | | | | | | | |

From the results shown in Table 1, it can be seen that the electromagnetic conversion characteristic is improved as the average magnetic cluster size is reduced. From the results shown in the table, the electromagnetic conversion characteristic is considered to be improved if the average magnetic cluster size is, for example, 1850 nm² or less, more preferably 1800 nm² or less, and still more preferably 1750 nm² or less, 1700 nm² or less, 1650 nm² or less, or 1600 nm² or less.

Furthermore, from the results shown in Table 1, it can also be seen that even if the magnetic powder has a small average particle volume (of, for example, 1453 nm³ in Comparative Example 1 or 965 nm³ in Comparative Example 3), the electromagnetic conversion characteristic deteriorates due to the excessively large average magnetic cluster size.

### 4-2. Evaluation of Influence of Protrusions Formed by First Particles and Second Particles on Electromagnetic Conversion Characteristic

Reducing the average magnetic cluster size can affect the state of the inorganic particles, particularly the state of the protrusions formed by the inorganic material on the magnetic layer side surface. Therefore, the influence was evaluated. Specifically, the following magnetic tapes were prepared. In addition to the magnetic tapes of Examples 1 and 2 described above, magnetic tapes of Examples 3 to 7 and magnetic tapes of Comparative Examples 5 and 6 described below were prepared. For these magnetic tapes, the heights of the protrusions formed by the inorganic particles were measured, and the traveling performance of these magnetic tapes was evaluated.

### Example 3

A magnetic tape was obtained in a manner similar to that in Example 1 except that a magnetic powder having an average particle volume of about 1050 nm³ was used, the amount of alumina added was reduced, and the thicknesses of the magnetic layer, the underlayer, and the back layer were changed. Then, using the magnetic tape, a magnetic recording cartridge was obtained in a manner similar to that in Example 1.

The obtained magnetic tape had an average magnetic cluster size of 1490 nm² as shown in Table 2 below.

### Example 4

A magnetic tape was obtained in a manner similar to that in Example 1 except that a magnetic powder having an average particle volume of about 1100 nm³ was used, the amount of alumina added was reduced, and the thicknesses of the magnetic layer, the underlayer, and the back layer were changed. Then, using the magnetic tape, a magnetic recording cartridge was obtained in a manner similar to that in Example 1.

The obtained magnetic tape had an average magnetic cluster size of 1431 nm² as shown in Table 2 below.

### Example 5

A magnetic tape was obtained in a manner similar to that in Example 1 except that a magnetic powder having an average particle volume of about 1400 nm³ was used and the dispersion time was lengthened. Then, using the magnetic tape, a magnetic recording cartridge was obtained in a manner similar to that in Example 1.

The obtained magnetic tape had an average magnetic cluster size of 1450 nm² as shown in Table 2 below.

### Example 6

A magnetic tape was obtained in a manner similar to that in Example 1 except that a magnetic powder having an average particle volume of about 1400 nm³ was used and the thicknesses of the base material layer and the back layer were changed. Then, using the magnetic tape, a magnetic recording cartridge was obtained in a manner similar to that in Example 1.

The obtained magnetic tape had an average magnetic cluster size of 1682 nm² as shown in Table 2 below.

### Example 7

A magnetic tape was obtained in a manner similar to that in Example 1 except that a magnetic powder having an average particle volume of about 1050 nm³ was used and the thicknesses of the magnetic layer, the underlayer, and the back layer were changed. Then, using the magnetic tape, a magnetic recording cartridge was obtained in a manner similar to that in Example 1.

The obtained magnetic tape had an average magnetic cluster size of 1510 nm² as shown in Table 2 below.

### Comparative Example 5

A magnetic tape was obtained in a manner similar to that in Example 1 except that the amount of alumina added was reduced and the thickness of the back layer was changed. Then, using the magnetic tape, a magnetic recording cartridge was obtained in a manner similar to that in Example 1.

The obtained magnetic tape had an average magnetic cluster size of 1706 nm² as shown in Table 2 below.

### Comparative Example 6

A magnetic tape was prepared that included a magnetic powder having a large average particle volume and had a large average magnetic cluster size. The magnetic tape had an average magnetic cluster size of 2470 nm^{z} as shown in Table 2 below.

### [Evaluation of Electromagnetic Conversion Characteristic]

Using the magnetic recording cartridges manufactured in Examples 1 to 7 and Comparative Examples 5 and 6, the electromagnetic conversion characteristic of the magnetic tape accommodated in each cartridge was evaluated. The evaluation was performed as described in 4-1. above.

### [Evaluation of Traveling Performance]

Using the magnetic recording cartridges manufactured in Examples 1 to 7 and Comparative Examples 5 and 6, the traveling performance of the magnetic tape accommodated in each cartridge was evaluated. The traveling performance was evaluated by measuring the standard deviation σPES described in 4-1. above. The evaluation criteria of the traveling performance based on the standard deviation σPES are as follows.
σPES is 50 nm or less within 40 FV number: traveling performance is excellent
σPES is more than 50 nm within 40 FV number: traveling performance is poor

Table 2 below shows the measurement results of each tape and the evaluation results of the electromagnetic conversion characteristic and the traveling performance. Note that “-” in the table means that no measurement was performed.

TABLE 2
Configuration and Evaluation Result of a Magnetic recording medium

| | | | | | | | | | | Second particle | |
|---|---|---|---|---|---|---|---|---|---|---|---|
| | | Average | Layer configuration of tape | | | | | | | (Al₂O₃) | |
| | Average | particle | Magnetic | Under- | Base | Back | | | | Number | Average |
| | magnetic | volume of | layer | layer | layer | layer | Total | | Vertical | of protru- | height of |
| | cluster | magnetic | thick- | thick- | thick- | thick- | thick- | | direction | sions per | protru- |
| | size | powder | ness | ness | ness | ness | ness | Vertical | Hc | unit area | sions H₂ |
| | (nm²) | (nm³) | (nm) | (μm) | (μm) | (μm) | (μm) | orientation | (kA/m) | (counts/μm²) | (nm) |
| Example 1 | 1690 | 1680 | 80 | 1.00 | 4.00 | 0.50 | 5.58 | Present | 216 | 3.7 | 5 |
| Example 2 | 1702 | 1690 | 75 | 0.70 | 4.00 | 0.40 | 5.18 | Absent | 202 | 3.4 | 6 |
| Example 3 | 1490 | 1051 | 70 | 0.70 | 4.00 | 0.40 | 5.17 | Present | 183 | 3.1 | 5.2 |
| Example 4 | 1431 | 1118 | 70 | 0.80 | 4.00 | 0.35 | 5.22 | Present | 185 | 3.1 | 4.8 |
| Example 5 | 1450 | 1378 | 80 | 1.00 | 4.00 | 0.50 | 5.58 | Absent | 211 | 3.5 | 5.5 |
| Example 6 | 1682 | 1453 | 80 | 1.00 | 3.80 | 0.35 | 5.23 | Present | — | 3.4 | 6.8 |
| Example 7 | 1510 | 1051 | 70 | 0.70 | 4.00 | 0.40 | 5.17 | Present | — | 3.7 | 7.5 |
| Comparative | 1706 | 1680 | 80 | 1.00 | 3.80 | 0.35 | 5.23 | Present | — | 2.8 | 4 |
| Example 5 | | | | | | | | | | | |
| Comparative | 2470 | 2400 | 85 | 1.10 | 4.00 | 0.45 | 5.64 | Absent | 226 | 3.7 | 5.1 |
| Example 6 | | | | | | | | | | | |

| | First particle | | | | | | | | |
|---|---|---|---|---|---|---|---|---|---|
| | (Carbon black) | | | | | | | Evaluation result | |
| | Number | Average | | | Amount | | Amount | | Electromagnetic |
| | of protru- | height of | | | of second | | of first | | conversion |
| | sions per | protru- | Ratio of | Size of | particles | Size of | particles | traveling | characteristic |
| | unit area | sions H₁ | H₁ to H₂ | second | (parts by | first | (parts by | performance | SNR |
| | (counts/μm²) | (nm) | (H₁/H₂) | particles | weight) | particles | weight) | (σPES) | (dB) |
| Example 1 | 1.7 | 7.6 | 1.52 | 80 | 7.5 | 70 | 2 | Good | 1.0 |
| Example 2 | 1.5 | 10.2 | 1.70 | 80 | 7.5 | 70 | 2 | Good | 1.1 |
| Example 3 | 1.5 | 8.4 | 1.62 | 80 | 5 | 70 | 2 | Good | 1.4 |
| Example 4 | 1.4 | 7.8 | 1.63 | 80 | 5 | 70 | 2 | Good | 1.5 |
| Example 5 | 1.2 | 7.5 | 1.36 | 80 | 7.5 | 70 | 2 | Good | 1.4 |
| Example 6 | 2.1 | 12.2 | 1.79 | 80 | 7.5 | 70 | 2 | Good | 0.3 |
| Example 7 | 2.3 | 11.3 | 1.51 | 80 | 7.5 | 70 | 3 | Good | 0.6 |
| Comparative | 1.6 | 8.1 | 2.03 | 80 | 5 | 70 | 2 | Poor | 1.0 |
| Example 5 | | | | | | | | | |
| Comparative | 1.4 | 11.3 | 2.22 | 80 | 7.5 | 70 | 2 | Poor | 0.0 |
| Example 6 | | | | | | | | | |

The following can be seen from the results shown in Table 2.

Comparison of the magnetic tapes of Examples 1 and 2 with the magnetic tape of Comparative Example 5 shows that the standard deviation σPES is low, that is, the traveling performance is excellent if the ratio (H₁/H₂) of the average height H₁ of the protrusions formed by the first particles (carbon black) to the average height H₂ of the protrusions formed by the second particles (Al₂O₃) is, for example, 2.0 or less, more preferably 1.95 or less, and still more preferably 1.90 or less, 1.85 or less, 1.80 or less, 1.75 or less, or 1.70 or less.

Furthermore, in Examples 1 and 2, the average magnetic cluster size is small, and as a result, the electromagnetic conversion characteristic is excellent, as described above.

From these results, it can be seen that excellent traveling performance can be achieved by controlling the ratio of the average height H₁ of the protrusions formed by the first particles to the average height H₂ of the protrusions formed by the second particles in a magnetic tape having a small average magnetic cluster size.

Note that in Comparative Example 6 in which the average magnetic cluster size was large and the ratio (H₁/H₂) was large, the evaluation result of the electromagnetic conversion characteristic was indeed poor, and the traveling performance was also poor.

Furthermore, comparison of Examples 1 and 2 with Examples 3 to 5 shows that the electromagnetic conversion characteristic can be further improved, while the traveling performance is excellent, by setting the ratio (H₁/H₂) to 2.0 or less and further reducing the average magnetic cluster size. Therefore, in order to obtain a still more excellent electromagnetic conversion characteristic, the average magnetic cluster size is more preferably 1700 nm² or less, 1650 nm² or less, or 1600 nm² or less, and still more preferably 1550 nm² or less or 1500 nm² or less.

Furthermore, comparison of Examples 1 and 2 with Examples 6 and 7 shows that if the ratio (H₁/H₂) is 2.0 or less, the traveling performance is excellent, but the electromagnetic conversion characteristic may deteriorate according to the values of the average height H₁ of the protrusions formed by the first particles and the average height H₂ of the protrusions formed by the second particles, which are involved in the ratio.

From these results, in order to obtain an excellent electromagnetic conversion characteristic, the average height H₁ of the protrusions formed by the first particles is preferably 12.0 nm or less, more preferably 11.5 nm or less, and still more preferably 11.0 nm or less, 10.5 nm or less, 10.0 nm or less, 9.5 nm or less, 9.0 nm or less, or 8.5 nm or less.

Furthermore, in order to obtain an excellent electromagnetic conversion characteristic, the average height H₂ of the protrusions formed by the second particles is preferably 7.0 nm or less, more preferably 6.5 nm or less, and still more preferably 6.0 nm or less, 5.5 nm or less, or 5.3 nm or less.

As described above, regarding a magnetic tape having a small magnetic cluster size (of, for example, 1850 nm² or less), it is considered that an excellent electromagnetic conversion characteristic can be more reliably obtained by adjusting the ratio (H₁/H₂), and in addition, the average height H₁ and the average height H₂ involved in the ratio.

Although embodiments and Examples of the present technology are specifically described above, the present technology is not limited to the embodiments and Examples described above, and various modifications based on the technical idea of the present technology may be made.

For example, configurations, methods, steps, shapes, materials, numerical values, and the like described in the embodiments and Examples described above are merely examples, and different configurations, methods, steps, shapes, materials, numerical values, and the like may be used as needed. Furthermore, the chemical formulae of compounds and the like are representative and are not limited to the listed valences and the like as long as a common name of the same compound is used.

Furthermore, configurations, methods, steps, shapes, materials, numerical values, and the like of the embodiments and Examples described above can be combined with each other without departing from the gist of the present technology.

Furthermore, in the present description, a numerical value range indicated by using “to” indicates a range including numerical values described before and after “to” as the minimum value and the maximum value, respectively. In the numerical value ranges described in stages in the present description, the upper limit or the lower limit of a numerical value range of a certain stage may be replaced with the upper limit or the lower limit of a numerical value range of another stage. The materials exemplified in the present description may be used alone or in combination of two or more thereof unless otherwise specified.

### REFERENCE SIGNS LIST

10 Magnetic recording medium
11 Base layer
12 Underlayer
13 Magnetic layer
14 Back layer

1. A magnetic recording medium comprising a magnetic layer containing a magnetic powder,
the magnetic recording medium having an average magnetic cluster size of 1850 nm² or less, the average magnetic cluster size measured on a basis of an MFM image of a surface on a side of the magnetic layer,
the magnetic layer containing first particles having conductivity and second particles having a Mohs hardness of 7 or more, wherein
protrusions are formed by the first particles and protrusions are formed by the second particles on the surface on the side of the magnetic layer, and
a ratio (H₁/H₂) of an average height H₁ of the protrusions formed by the first particles to an average height H₂ of the protrusions formed by the second particles is 2.00 or less.

2. The magnetic recording medium according to claim 1, wherein the average height H₁ is 13.0 nm or less.

3. The magnetic recording medium according to claim 1, wherein the average height H₁ is 12.0 nm or less.

4. The magnetic recording medium according to claim 1, wherein the average height H₁ is 11.0 nm or less.

5. The magnetic recording medium according to claim 1, wherein the average height H₂ is 7.5 nm or less.

6. The magnetic recording medium according to claim 1, wherein the average height H₂ is 7.0 nm or less.

7. The magnetic recording medium according to claim 1, wherein the average height H₂ is 6.5 nm or less.

8. The magnetic recording medium according to claim 1, wherein the average magnetic cluster size is 1800 nm² or less.

9. The magnetic recording medium according to claim 1, wherein the average magnetic cluster size is 1700 nm² or less.

10. The magnetic recording medium according to claim 1, wherein the average magnetic cluster size is 1600 nm² or less.

11. The magnetic recording medium according to claim 1, having an average thickness t_{T} of 5.1 μm or less.

12. The magnetic recording medium according to claim 1, having a coercive force Hc in a vertical direction of the magnetic recording medium of 165 kA/m or more and 300 kA/m or less.

13. The magnetic recording medium according to claim 1, wherein the first particles include carbon particles.

14. The magnetic recording medium according to claim 1, wherein the second particles include inorganic particles.

15. The magnetic recording medium according to claim 1, wherein a number of the protrusions formed by the first particles on the surface on the side of the magnetic layer is 2.5 or less per unit area (μm²).

16. The magnetic recording medium according to claim 1, wherein a number of the protrusions formed by the second particles on the surface on the side of the magnetic layer is 2.0 or more per unit area (μm²).

17. The magnetic recording medium according to claim 1, wherein the magnetic layer has an average thickness of 0.08 μm or less.

18. A magnetic recording medium comprising a magnetic layer containing a magnetic powder,
the magnetic recording medium having an average magnetic cluster size of 1850 nm² or less, the average magnetic cluster size measured on a basis of an MFM image of a surface on a side of the magnetic layer,
the magnetic recording medium having a coercive force Hc in a vertical direction of the magnetic recording medium of 165 kA/m or more and 300 kA/m or less.

19. A magnetic recording cartridge comprising the magnetic recording medium according to claim 1 in a state of being wound around a reel, the magnetic recording medium accommodated in a case.
